(19) United States
(12) Patent Application Publication
(10) Pub. No.: US 2026/0171671 A1
(43) Pub. Date: Jun. 18, 2026

(54) OMNIDIRECTIONAL ANTENNA AND DISTRIBUTED ANTENNA SYSTEM

(71) Applicant: BOE Technology Group Co., Ltd., Beijing (CN)

(72) Inventors: Huiying Zhao, Beijing (CN); Yukai Zhang, Beijing (CN); Dongdong Zhang, Beijing (CN); Jie Yang, Beijing (CN); Shihua Wang, Beijing (CN); Feng Qu, Beijing (CN); Mengwen Jia, Beijing (CN); Zibo Cao, Beijing (CN)

(73) Assignee: BOE Technology Group Co., Ltd., Beijing (CN)

(21) Appl. No.: 18/710,881

(22) PCT Filed: Aug. 31, 2023
(86) PCT No.: PCT/CN2023/116226

§ 371 Date: May 16, 2024

(51) Int. Cl. H01Q 9/28; H01Q 5/371; H01Q 13/02

(52) U.S. Cl. CPC H01Q 9/285; H01Q 5/371; H01Q 13/02

(57) ABSTRACT

The present disclosure provides an omnidirectional antenna and a distributed antenna system, which relates to the technical field of antennas. The omnidirectional antenna includes an upper taper oscillator, a lower taper oscillator, a medium plate and an auxiliary branch; the upper taper oscillator and the lower taper oscillator are arranged separately in a first direction, and a taper vertex of the upper taper oscillator and a taper vertex of the lower taper oscillator are opposite to each other; the medium plate is perpendicular to the first direction, the medium plate includes a plurality of radiating components, and the plurality of radiating components are arranged in a circular array around the taper vertex; and the auxiliary branch is made from a conductor, and the auxiliary branch is connected to one or more of the upper taper oscillator, the lower taper oscillator and the medium plate.

### TECHNICAL FIELD

The present disclosure relates to the technical field of antennas, and particularly relates to an omnidirectional antenna and a distributed antenna system.

### BACKGROUND

With the increasingly higher urbanization rate, the urban building density is increasingly higher. The dense constructions easily block wireless signals, which affects the wireless-communication quality. In order to solve that problem, omnidirectional antennas provided inside constructions emerge accordingly. The signals between the omnidirectional antenna provided indoor and the communication terminals are easily affected by obstacles and other electric apparatuses, which results in reduced signal intensities and deteriorated signal-to-noise ratios. How to improve the performance of the omnidirectional antenna and improve the communication quality is a technical problem required to be solved urgently.

### SUMMARY

The embodiments of the present disclosure provide an omnidirectional antenna and a distributed antenna system, which improves the communication quality.

In order to achieve the above object, the embodiments of the present disclosure employ the following technical solutions:

In an aspect, there is provided an omnidirectional antenna, wherein the omnidirectional antenna includes an upper taper oscillator, a lower taper oscillator, a medium plate and an auxiliary branch;
the upper taper oscillator and the lower taper oscillator are arranged separately in a first direction, and a taper vertex of the upper taper oscillator and a taper vertex of the lower taper oscillator are opposite to each other;
the medium plate is perpendicular to the first direction, the medium plate includes a plurality of radiating components, and the plurality of radiating components are arranged in a circular array around the taper vertex; and
the auxiliary branch is made from a conductor, and the auxiliary branch is connected to one or more of the upper taper oscillator, the lower taper oscillator and the medium plate.

In some embodiments, the auxiliary branch includes a gain branch, the gain branch is provided at the medium plate, and the gain branch is located between two neighboring instances of the radiating components, and is separate from the radiating components.

In some embodiments, the medium plate includes a first electrically conducting layer, a second electrically conducting layer and a medium base board located between the first electrically conducting layer and the second electrically conducting layer, the radiating components are located at the first electrically conducting layer, the second electrically conducting layer includes an earthing component, and the gain branch is connected to one side of the medium base board that faces the first electrically conducting layer.

In some embodiments, the gain branch is provided between each two neighboring instances of the radiating components.

In some embodiments, the gain branch extends in a radial direction of the circular array, and the two neighboring instances of the radiating components adjacent to the gain branch is symmetrical with respect to the gain branch.

In some embodiments, the gain branch includes a plurality of gain sub-branches, and the plurality of gain sub-branches in a same gain branch are arranged separately in the radial direction of the circular array, or the plurality of gain sub-branches in the same gain branch are arranged separately in a circumferential direction of the circular array.

In some embodiments, an axis of symmetry of the two neighboring instances of the radiating components is a first axis of symmetry, and if the plurality of gain sub-branches in the same gain branch are arranged separately in the circumferential direction of the circular array, the plurality of gain sub-branches in the same gain branch are symmetrical with respect to the first axis of symmetry.

In some embodiments, the gain branch is located at the first electrically conducting layer.

In some embodiments, the gain branch includes a main body extending in a radial direction of the circular array and a plurality of branches connected to the main body, and the plurality of branches are arranged separately in the radial direction of the circular array.

In some embodiments, the main body is of a rectangle, a prismatic shape, a trapezoid, a wave shape or an irregular shape.

In some embodiments, each of the radiating components includes a radiating dipole, and each of two opposite ends of the radiating dipole includes a bending part extending toward a center of the circular array.

In some embodiments, one end of the gain branch away from the center of the circular array is opposite to the bending part.

In some embodiments, the second electrically conducting layer further includes a complementary dipole, an orthographic projection on the medium base board of the radiating dipole and an orthographic projection on the medium base board of the complementary dipole do not overlap, and both of the complementary dipole and the gain branch are electrically connected to the earthing component.

In some embodiments, the first electrically conducting layer further includes a power divider and a balun, and the power divider and the balun are electrically connected.

In some embodiments, the gain branch is connected to the side of the medium base board that faces the first electrically conducting layer, and the gain branch protrudes out of the first electrically conducting layer in the first direction.

In some embodiments, the auxiliary branch further includes a parasitic branch, and the parasitic branch protrudes out of an outer surface of one or more of the upper taper oscillator, the lower taper oscillator and the medium plate.

In some embodiments, the parasitic branch surrounds a circumferential direction of the upper taper oscillator or the lower taper oscillator.

In some embodiments, the parasitic branch is of a round-ring shape, and the parasitic branch is nested to an outer surface of the upper taper oscillator or the lower taper oscillator; or
the omnidirectional antenna includes a plurality of parasitic branches, and the plurality of parasitic branches are arranged separately in the circumferential direction of the upper taper oscillator or the lower taper oscillator.

In some embodiments, a direction of extension of a virtual connecting line between the antenna unit and a center of the circular array is a second direction, and a direction of extension of an axis of symmetry of two neighboring virtual connecting lines is a third direction; and
an orthographic projection of the parasitic branch on the medium plate extends in the second direction or the third direction, and the plurality of parasitic branches are arranged evenly in the circumferential direction of the upper taper oscillator or the lower taper oscillator.

In some embodiments, a quantity of the parasitic branches is n times or 1/n times a quantity of the antenna units, wherein n is a natural number and n≥1.

In some embodiments, an orthographic projection of the lower taper oscillator on the medium plate covers an orthographic projection of the upper taper oscillator on the medium plate, the upper taper oscillator includes a taper face and a columnar face connected to one end of the taper face away from the lower taper oscillator, and the parasitic branch is connected to the columnar face.

In some embodiments, one end of the parasitic branch away from the upper taper oscillator inclines toward the medium plate.

In some embodiments, an orthographic projection of the lower taper oscillator on the medium plate covers an orthographic projection of the upper taper oscillator on the medium plate, a first end of the parasitic branch is connected to the lower taper oscillator, and a second end of the parasitic branch is connected to and penetrates the medium plate.

In some embodiments, the medium plate is provided with a mounting hole, and the second end of the parasitic branch penetrates the mounting hole.

In some embodiments, the parasitic branch is electrically connected to a gain branch, and the parasitic branch extends in the first direction.

In another aspect, there is provided an omnidirectional antenna, wherein the omnidirectional antenna includes an upper taper oscillator, a lower taper oscillator, a medium plate and a parasitic branch;
the upper taper oscillator and the lower taper oscillator are arranged separately in a first direction, and a taper vertex of the upper taper oscillator and a taper vertex of the lower taper oscillator are opposite to each other;
the medium plate is perpendicular to the first direction, the medium plate includes a plurality of radiating components, and the plurality of radiating components are arranged in a circular array around the taper vertex; and
the parasitic branch is made from a conductor, and the parasitic branch is electrically connected to the upper taper oscillator and protrudes out of an outer surface of the upper taper oscillator, or the parasitic branch is electrically connected to the lower taper oscillator and protrudes out of an outer surface of the lower taper oscillator.

In some embodiments, the omnidirectional antenna further includes a plurality of fixing frames, one end of each of the fixing frames is riveted to the upper taper oscillator, the other end of the fixing frame is riveted to the lower taper oscillator, and the plurality of fixing frames are arranged separately in a circumferential direction of the upper taper oscillator.

In some embodiments, the omnidirectional antenna further includes a fixing tube, a first end of the fixing tube is fixedly connected to the lower taper oscillator, and the taper vertex of the upper taper oscillator is inserted into a second end of the fixing tube.

In some embodiments, one end of the lower taper oscillator that faces the upper taper oscillator is provided with a slot, and the first end of the fixing tube is inserted into the slot.

In some embodiments, the slot includes a plurality of sub-slots provided separately in a circumferential direction of the lower taper oscillator, the first end of the fixing tube is provided with a plurality of positioning parts, and the positioning parts are inserted into the sub-slots.

In some embodiments, the medium plate is located between the upper taper oscillator and the lower taper oscillator and is fixed to the lower taper oscillator, a hollow region is provided at a position of the medium plate that corresponds to the taper vertex, and the first end of the fixing tube is inserted into the hollow region and is fixedly connected to the medium plate.

In yet another aspect, there is provided an omnidirectional antenna, wherein the omnidirectional antenna includes a medium plate and a gain branch;
the medium plate includes a first electrically conducting layer, a second electrically conducting layer and a medium base board located between the first electrically conducting layer and the second electrically conducting layer, the first electrically conducting layer includes a plurality of radiating components, the plurality of radiating components surround a taper vertex and are arranged in a circular array, and the second electrically conducting layer includes an earthing component; and
the gain branch is connected to one side of the medium base board that faces the first electrically conducting layer, the gain branch is located between two neighboring instances of the radiating components, and the gain branch is made from a conductor and is separate from the radiating components.

In still another aspect, there is provided a distributed antenna system, wherein the distributed antenna system includes the omnidirectional antenna.

### BRIEF DESCRIPTION OF THE DRAWINGS

In order to more clearly illustrate the technical solutions of the embodiments of the present disclosure or the prior art, the figures that are required to describe the embodiments or the prior art will be briefly described below. Apparently, the figures that are described below are merely embodiments of the present disclosure, and a person skilled in the art can obtain other figures according to these figures without paying creative work.

FIG. 1 illustratively shows a diagram of an application scene of an omnidirectional antenna;

FIG. 2 is a view in the direction A of the omnidirectional antenna in FIG. 1;

FIG. 3 is a sectional view along B-B in FIG. 2;

FIG. 4 illustratively shows a partially structural diagram of an omnidirectional antenna;

FIG. 5 illustratively shows a partially structural diagram of an omnidirectional antenna;

FIG. 6 illustratively shows a structural diagram of a fixing frame;

FIG. 7 illustratively shows a partially exploded structural view of an omnidirectional antenna;

FIG. 8 illustratively shows a partially exploded structural view of an omnidirectional antenna;

FIG. 9 illustratively shows a sectional view of a medium plate;

FIG. 10 illustratively shows a partially schematic structural diagram of an omnidirectional antenna;

FIG. 11 illustratively shows a sectional view of an omnidirectional antenna;

FIG. 12 illustratively shows a partially schematic structural diagram of an omnidirectional antenna;

FIG. 13 illustratively shows a partially schematic structural diagram of an omnidirectional antenna;

FIG. 14 illustratively shows a sectional view of an omnidirectional antenna;

FIG. 15 illustratively shows a top view of a partially structure an omnidirectional antenna;

FIG. 16 illustratively shows a schematic diagram of an omnidirectional antenna;

FIG. 17 shows a simulation diagram of the radiation directions of an omnidirectional antenna not provided with the parasitic branch;

FIG. 18 shows a simulation diagram of the radiation directions of the omnidirectional antenna shown in FIG. 10;

FIG. 19 shows a standing wave of an omnidirectional antenna not provided with the parasitic branch;

FIG. 20 shows a standing wave of the omnidirectional antenna shown in FIG. 10;

FIG. 21 illustratively shows a partially structural diagram of an omnidirectional antenna;

FIG. 22 is a top view of FIG. 21;

FIG. 23 illustratively shows a partially structural diagram of an omnidirectional antenna;

FIG. 24 illustratively shows a front view of a medium plate;

FIG. 25 illustratively shows a back view of a medium plate;

FIG. 26 illustratively shows a perspective view of a medium plate;

FIG. 27 illustratively shows a structural diagram of a medium plate;

FIG. 28 shows a simulation diagram of the radiation directions of an omnidirectional antenna including the medium plate shown in FIG. 26;

FIG. 29 shows a simulation diagram of the radiation directions of an omnidirectional antenna including the medium plate shown in FIG. 27;

FIG. 30 shows a diagram of the S parameter of an omnidirectional antenna including the medium plate shown in FIG. 26;

FIG. 31 shows a diagram of the S parameter of an omnidirectional antenna including the medium plate shown in FIG. 27;

FIG. 32 illustratively shows a structural diagram of another medium plate;

FIG. 33 shows a simulation diagram of the radiation directions of an omnidirectional antenna including the medium plate shown in FIG. 32;

FIG. 34 illustratively shows a structural diagram of another medium plate;

FIG. 35 shows a structural diagram of the gain branch of the medium plate shown in FIG. 27;

FIG. 36 illustratively shows a structural diagram of another medium plate;

FIG. 37 shows a simulation diagram of the radiation directions of an omnidirectional antenna including the medium plate shown in FIG. 36;

FIG. 38 illustratively shows a structural diagram of another medium plate;

FIG. 39 shows a simulation diagram of the radiation directions of an omnidirectional antenna including the medium plate shown in FIG. 38;

FIG. 40 illustratively shows a structural diagram of another medium plate;

FIG. 41 illustratively shows a partially structural diagram of an omnidirectional antenna;

FIG. 42 shows a simulation diagram of the radiation directions of the omnidirectional antenna shown in FIG. 41;

FIG. 43 illustratively shows a partially structural diagram of an omnidirectional antenna;

FIG. 44 shows a simulation diagram of the radiation directions of the omnidirectional antenna shown in FIG. 43;

FIG. 45 illustratively shows a partially structural diagram of another omnidirectional antenna; and

FIG. 46 illustratively shows a partially structural diagram of another omnidirectional antenna.

### DETAILED DESCRIPTION

The technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

In the embodiments of the present disclosure, terms such as “first”, “second”, “third” and “fourth” are used to distinguish identical items or similar items that have substantially the same functions and effects, merely in order to clearly describe the technical solutions of the embodiments of the present disclosure, and should not be construed as indicating or implying the degrees of importance or implicitly indicating the quantity of the specified technical features.

In the embodiments of the present disclosure, the meaning of “plurality of” is “two or more”, and the meaning of “at least one” is “one or more”, unless explicitly and particularly defined otherwise.

In the embodiments of the present disclosure, the terms that indicate orientation or position relations, such as “upper” and “lower”, are based on the orientation or position relations shown in the drawings, and are merely for conveniently describing the present disclosure and simplifying the description, rather than indicating or implying that the device or element must have the specific orientation and be constructed and operated according to the specific orientation. Therefore, they should not be construed as a limitation on the present disclosure.

The embodiments of the present disclosure provide a distributed antenna system, which may be applied inside constructions such as a parking lot, an office building, a hotel, an apartment, a railway station, an airport, a marketplace and a gymnasium, to improve the quality of mobile communication inside the constructions.

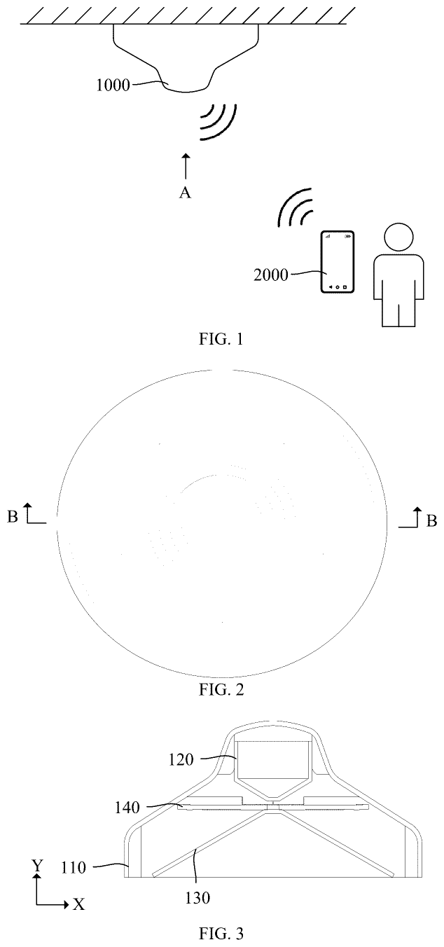

The distributed antenna system includes a plurality of omnidirectional antennas, and the plurality of omnidirectional antennas are distributed at different positions inside the construction, to enlarge the signal coverage of the distributed antenna system. The omnidirectional antennas may have various forms, and, in order to facilitate the illustration, in the embodiments of the present disclosure merely the case is taken as an example for exemplary illustration in which the omnidirectional antennas are ceiling indoor antennas. FIG. 1 illustratively shows a diagram of an application scene of an omnidirectional antenna. As shown in FIG. 1, the omnidirectional antenna is located inside the construction, and is hung at the top of the construction. A communication terminal 2000 of the user realizes wireless communication by using the omnidirectional antenna 1000.

As an example, the distributed antenna system further includes the devices such as a signal source, a coupler, a power divider 30, a radio-frequency coaxial cable and a cable connector. The signal of the signal source is shunted by the devices such as the coupler and the power divider 30, and the signals are distributed via the radio-frequency coaxial cable to the plurality of omnidirectional antennas 1000. The signal source may be a base station, a repeater or another device of the wireless communication system.

### The First Embodiment

FIG. 2 is a view in the direction A of the omnidirectional antenna 1000 in FIG. 1. FIG. 3 is a sectional view along B-B in FIG. 2. As shown in FIGS. 2 and 3, the omnidirectional antenna 1000 includes an antenna housing 110, and an upper taper oscillator 120, a lower taper oscillator 130 and a medium plate 140 that are provided inside the antenna housing 110.

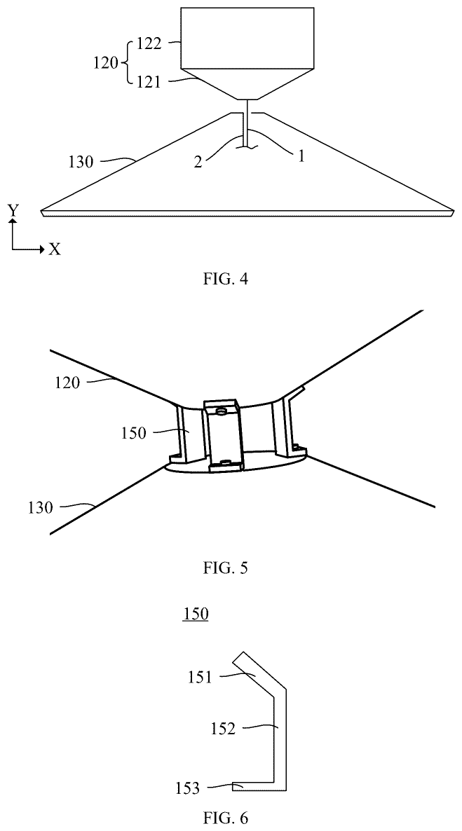

FIG. 4 illustratively shows a partially structural diagram of an omnidirectional antenna 1000. In order to facilitate the illustration, FIG. 4 merely shows the upper taper oscillator 120, the lower taper oscillator 130 and a signal line, and does not show the components such as the antenna housing 110 and the medium plate 140. As shown in FIG. 4, the upper taper oscillator 120 and the lower taper oscillator 130 are arranged separately in a first direction Y, and the taper vertex of the upper taper oscillator 120 and the taper vertex of the lower taper oscillator 130 face each other. The upper taper oscillator 120 and the lower taper oscillator 130 are configured to form vertically polarized radiation.

The antenna housing 110 is used to connect and protect the upper taper oscillator 120, the lower taper oscillator 130, the medium plate 140 and the other component elements of the omnidirectional antenna 1000. The antenna housing 110 has a good transmittance of electromagnetic waves. As an example, the antenna housing 110 is made from a plastic material.

When the omnidirectional antenna 1000 is installed in the mode shown in FIG. 1, the oscillator located at the upper part is the lower taper oscillator 130, the oscillator located at the lower part is the upper taper oscillator 120, and the upper taper oscillator 120 and the lower taper oscillator 130 are arranged separately in the direction perpendicular to the ground; in other words, the first direction Y is perpendicular to the ground.

Both of the upper taper oscillator 120 and the lower taper oscillator 130 are of a thin-shell structure, and both of the upper taper oscillator 120 and the lower taper oscillator 130 include a taper face, wherein the point part of the taper face is the taper vertex. The taper face may be a circular conical face, a pyramidal face, a truncated circular conical face, a truncated pyramidal face, or an irregular taper face, as long as it is satisfied that, from the end further from the taper vertex to the end of the taper vertex, the size of the taper face gradually decreases. In the embodiments of the present disclosure merely the case is taken as an example for exemplary illustration in which the taper face is a circular conical face and a truncated circular conical face.

Referring continuously to FIG. 4, the upper taper oscillator 120 includes an upper taper face 121 and an upper columnar face 122, and the upper columnar face 122 is connected to the end of the upper taper face 121 away from the lower taper oscillator 130. As an example, if the upper taper face 121 is a circular conical face, the upper columnar face 122 is a circular columnar face. If the upper taper face 121 is a pyramidal face, the upper columnar face 122 is a prismatic face.

Certainly, the lower taper oscillator 130 may also include a lower taper face and a lower columnar face, which is not limited in the embodiments of the present disclosure.

As an example, the end of the upper taper oscillator 120 away from the lower taper oscillator 130 and the end of the lower taper oscillator 130 away from the upper taper oscillator 120 may also be of a sawtooth shape.

As an example, the upper taper oscillator 120 is symmetrical with respect to its own central axis, the lower taper oscillator 130 is symmetrical with respect to its own central axis, and the central axis of the upper taper oscillator 120 and the central axis of the lower taper oscillator 130 coincide.

The upper taper oscillator 120 and the lower taper oscillator 130 may be made from a conductor, for example, a metal and a carbon fiber. As an example, referring continuously to FIG. 4, the omnidirectional antenna 1000 may further include a signal line. The signal line includes a core wire 1 and a shielding wire 2 nested outside the core wire 1, the shielding wire 2 is electrically connected to the lower taper oscillator 130, the core wire 1 is electrically connected to the upper taper oscillator 120, and the core wire 1 and the lower taper oscillator 130 are insulated from each other. The signal line may be used to send signals to the upper taper oscillator 120 and the lower taper oscillator 130, to energize the upper taper oscillator 120 and the lower taper oscillator 130 to generate the vertically polarized radiation.

The relative position between the upper taper oscillator 120 and the lower taper oscillator 130 directly influences the performance of the omnidirectional antenna 1000, and therefore it is required to fix the upper taper oscillator 120 and the lower taper oscillator 130, to prevent changing of the relative position between the upper taper oscillator 120 and the lower taper oscillator 130 in the omnidirectional antenna 1000. In the related art, the fixing of the upper taper oscillator 120 and the lower taper oscillator 130 is usually realized by using the signal line. For example, the core wire 1 and the shielding wire 2 of the signal line are fixed to each other, the core wire 1 is connected to the upper taper oscillator 120, and the shielding wire 2 is connected to the lower taper oscillator 130, whereby the upper taper oscillator 120 and the lower taper oscillator 130 are fixed. However, because the core wire 1 is fine and is flexible to a certain extent, when the omnidirectional antenna 1000 is being vibrated, the upper taper oscillator 120 easily swings relative to the lower taper oscillator 130.

In view of the above, in the embodiments of the present disclosure a fixing member may be provided separately to realize the fixing of the upper taper oscillator 120 and the lower taper oscillator 130. The fixing member may have various structures, and several feasible structures of the fixing member and the connection mode of the fixing member to the upper taper oscillator 120 and the lower taper oscillator 130 will be described below.

FIG. 5 illustratively shows a partially structural diagram of an omnidirectional antenna 1000. As shown in FIG. 5, the fixing member may include a plurality of fixing frames 150, and the plurality of fixing frames 150 are arranged separately in the circumferential direction of the upper taper oscillator 120. One end of each of the fixing frames 150 is fixedly connected to the upper taper oscillator 120, and the other end of the fixing frame 150 is fixedly connected to the lower taper oscillator 130.

As an example, the fixed connection of the fixing frame 150 to the upper taper oscillator 120 and the lower taper oscillator 130 may be adhesive bonding, ultrasonic welding, riveting, snap fitting and so on, and may also be that the fixing frame 150 and the upper taper oscillator 120 and/or the lower taper oscillator 130 are processed into an integral structure by integral formation.

FIG. 6 illustratively shows a structural diagram of a fixing frame 150. As an example, as shown in FIGS. 5 and 6, the lower taper oscillator 130 is a truncated circular conical face, the truncated circular conical face includes a flat surface facing the upper taper oscillator 120, and the fixing frame 150 includes a first connecting part 153 connected to the flat surface of the lower taper oscillator 130, a second connecting part 151 connected to the upper taper oscillator 120, and a supporting part 152 located between the first connecting part 153 and the second connecting part 151. The supporting part 152 extends in the first direction Y, and the second connecting part 151 inclines by a certain angle relative to the first direction Y, whereby the second connecting part 151 adheres to the surface of the upper taper oscillator 120. The first connecting part 153 extends in a second direction X, whereby the first connecting part 153 adheres to the flat surface of the lower taper oscillator 130.

The plurality of fixing frames 150 may be distributed evenly in the circumferential direction of the taper vertex. FIG. 5 shows a case in which three fixing frames 150 are included. When three fixing frames 150 are included, the included angle between two neighboring fixing frames 150 is 120°, which reduces the quantity of the fixing frames 150 while ensuring the fastness between the upper taper oscillator 120 and the lower taper oscillator 130. Certainly, the quantity of the fixing frames 150 may also be two, four, five, six and so on, and the quantity of the fixing frames 150 is not limited in the embodiments of the present disclosure.

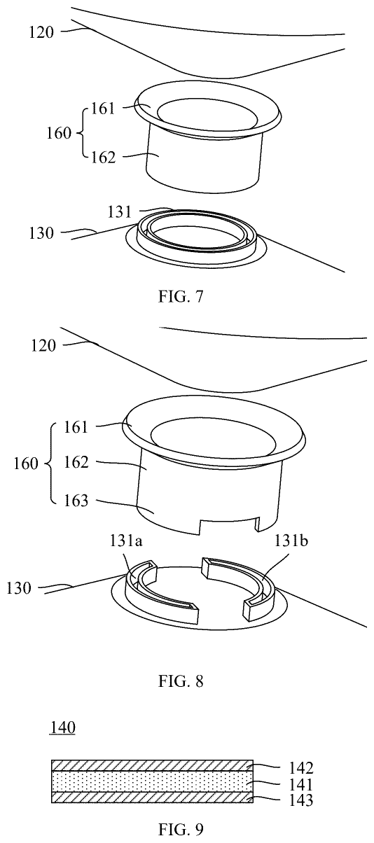

FIG. 7 illustratively shows a partially exploded structural view of an omnidirectional antenna 1000. As shown in FIG. 7, the fixing member may include a fixing tube 160, a first end of the fixing tube 160 is fixedly connected to the lower taper oscillator 130, and the taper vertex of the upper taper oscillator 120 is inserted into a second end of the fixing tube 160.

The taper vertex of the upper taper oscillator 120, after inserted into the second end of the fixing tube 160, may be fixedly connected to the fixing tube 160, to restrict the rotation of the upper taper oscillator 120 relative to the fixing tube 160. The fixed connection of the fixing frame 150 to the upper taper oscillator 120 may be adhesive bonding, ultrasonic welding, riveting, snap fitting and so on.

As an example, referring continuously to FIG. 7, the fixing tube 160 includes a tubular main body 162 and a conical opening 161 connected to one end of the tubular main body 162, and the taper vertex of the upper taper oscillator 120 is inserted into the conical opening 161. The taper of the conical opening 161 may be equal to the taper of the taper vertex of the upper taper oscillator 120, so that, when the taper vertex of the upper taper oscillator 120 is inserted into the conical opening 161, the outer surface of the upper taper oscillator 120 adheres to the inner wall of the conical opening 161, whereby the connection between the upper taper oscillator 120 and the fixing tube 160 is firmer.

That the fixing tube 160 is fixedly connected to the lower taper oscillator 130 refers to that the fixing tube 160 and the lower taper oscillator 130 cannot move relative to each other in the first direction. The fixing tube 160 and the lower taper oscillator 130 may rotate relative to each other around the first direction Y, and may also be not capable of rotating relative to each other.

The end of the lower taper oscillator 130 that faces the upper taper oscillator 120 may be provided with a slot 131, and the first end of the fixing tube 160 is inserted into the slot 131. By realizing the fixing between the fixing tube 160 and the lower taper oscillator 130 by using the fitting between the first end of the fixing tube 160 and the slot 131, the assembling is more convenient.

As an example, the lower taper oscillator 130 includes a flat surface facing the upper taper oscillator 120, the flat surface is provided with a round-ring-shaped first wall protruding out of the flat surface and a second wall nested outside the first wall, and the first wall and the second wall are arranged separately and define the slot 131. The first end of the fixing tube 160 is inserted between the first wall and the second wall.

The first end of the fixing tube 160 may rotate along the first wall and the second wall, or the first end of the fixing tube 160 is fixed relative to the first wall and the second wall; for example, the first end of the fixing tube 160 is interference-fitted to the first wall and the second wall, or an adhesive bonding glue is filled between the first end of the fixing tube 160 and the first wall and the second wall, and so on.

Certainly, the structural form of the slot 131 is not limited thereto, and may also be that the flat surface of the lower taper oscillator 130 that faces the upper taper oscillator 120 depresses in the direction further away from the upper taper oscillator 120 to form the slot 131. The first end of the fixing tube 160 is not limited to a cylindrical tube shape, and the cross-sectional shape perpendicular to the first direction Y of the first end of the fixing tube 160 may also be a triangle, a quadrangle, a pentagon and an irregular shape. In this case, the first wall and the second wall for forming the slot 131 may be adaptively modified according to the shape of the first end of the fixing tube 160.

FIG. 8 illustratively shows a partially exploded structural view of an omnidirectional antenna 1000. As shown in FIG. 8, the slot 131 may include a plurality of sub-slots, the plurality of sub-slots are arranged separately in the circumferential direction of the lower taper oscillator 130, the first end of the fixing tube 160 is provided with a plurality of positioning parts 163, and the plurality of positioning parts 163 are arranged separately in the circumferential direction of the fixing tube 160. The positioning parts 163 are inserted into the sub-slots, to realize the fixing between the fixing tube 160 and the lower taper oscillator 130. Additionally, because the plurality of sub-slots are arranged separately, the positioning parts 163 cannot rotate from one sub-slot to another sub-slot, which can restrict the rotation of the fixing tube 160 relative to the lower taper oscillator 130. For example, if the size of the positioning part 163 is equal to the size of the slot 131, the positioning part 163 cannot rotate inside the sub-slots after inserted into the sub-slots.

As an example, referring continuously to FIG. 8, the slot 131 includes two sub-slots, both of the two sub-slots are of a circular-arc shape, the first end of the fixing tube 160 is provided with two positioning parts 163, and the positioning parts 163 correspond to the sub-slots one to one.

Certainly, the fixing frames 150 and the fixing tube 160 may be included at the same time, which may be configured flexibly according to practical demands in practical applications.

It should be noted that both of the fixing frames 150 and the fixing tube 160 are made from an insulating material (for example, plastic), to prevent short circuiting between the upper taper oscillator 120 and the lower taper oscillator 130 via the fixing frames 150 and the fixing tube 160.

Referring continuously to FIG. 3, the medium plate 140 is perpendicular to the first direction Y; in other words, the plane where the medium plate 140 is located extends in the second direction X. The medium plate 140 may have various positions in the first direction Y. For example, the medium plate 140 may be located between the upper taper oscillator 120 and the lower taper oscillator 130, the medium plate 140 may also be located on the side of the lower taper oscillator 130 away from the upper taper oscillator 120, and the medium plate 140 may also be located on the side of the upper taper oscillator 120 away from the lower taper oscillator 130. In practical applications, in order to reduce the size of the omnidirectional antenna 1000, the medium plate 140 may be located between the upper taper oscillator 120 and the lower taper oscillator 130, or the medium plate 140 is located on the side of the lower taper oscillator 130 away from the upper taper oscillator 120.

If the medium plate 140 is located between the upper taper oscillator 120 and the lower taper oscillator 130, a hollow region 140a is provided at the position of the medium plate 140 that corresponds to the taper vertex, and the hollow region 140a extends throughout the medium plate 140 in the first direction Y. The core wire 1 may penetrate the hollow region 140a and be electrically connected to the upper taper oscillator 120.

As an example, the medium plate 140 is of a circular shape, and the circle-center region of the medium plate 140 is the hollow region 140a.

FIG. 9 illustratively shows a sectional view of a medium plate 140. As shown in FIG. 9, the medium plate 140 may include a first electrically conducting layer 142, a second electrically conducting layer 143 and a medium base board 141 located between the first electrically conducting layer 142 and the second electrically conducting layer 143.

The medium base board 141 may be a glass base board, a polytetrafluoroethylene glass-fiber press plate, an epoxy-resin base board, a polyimide base board and so on, and the material of the medium base board 141 is not limited in the embodiments of the present disclosure. The first electrically conducting layer 142 and the second electrically conducting layer 143 are made from a conductor, for example, aluminum, copper, silver and gold. The first electrically conducting layer 142 covers one side of the medium base board 141, and the second electrically conducting layer 143 covers the opposite side of the medium base board 141.

As an example, the medium plate 140 is fabricated by using a Printed Circuit Board (referred to for short as PCB) process.

The first electrically conducting layer 142 includes a radiating component, the second electrically conducting layer 143 includes an earthing component 50, and the radiating component, the earthing component 50 and the medium base board 141 located between the radiating component and the earthing component 50 form an antenna unit. The antenna unit is configured to form horizontally polarized radiation.

The first electrically conducting layer 142 may include a plurality of radiating components, and the plurality of radiating components surround the taper vertex and are arranged in a circular array. Each of the radiating components forms one antenna unit with the earthing component 50 and the medium base board 141, whereby the medium plate 140 includes a plurality of antenna units, and the plurality of antenna units form an antenna array.

As an example, if the medium plate 140 is of a circular shape, the plurality of radiating components are arranged in an array along the edge of the medium plate 140.

The antenna unit may be a patch antenna unit, and may also be a dipole antenna unit. If the antenna unit is a patch antenna unit, the radiating components are radiating patches, and the shape of the radiating patches may be a circle, an ellipse, a polygon such as a rectangle and a triangle, and an irregular shape, which is not limited in the embodiments of the present disclosure. If the antenna unit is a dipole antenna unit, the radiating components are radiating dipoles 10. Merely the case is taken as an example for exemplary illustration below in which the antenna unit is a dipole antenna unit.

In order to improve the performance of the omnidirectional antenna 1000, in the embodiments of the present disclosure an auxiliary branch is provided at one or more of the upper taper oscillator 120, the lower taper oscillator 130 and the medium plate 143. The auxiliary branch may include a gain branch, may also include a parasitic branch, and may also include both of a gain branch and an auxiliary branch.

Two important parameters of the omnidirectional antenna 1000 are the beam width and the gain of the omnidirectional antenna 1000.

In order to increase the beam width of the omnidirectional antenna 1000, the following several modes are usually employed in the related art:
The first mode is widening the beam width of the omnidirectional antenna 1000 by using a multi-stage resonance-ring antenna unit. However, the multi-stage resonance-ring antenna unit has a complicated structure, and requires a large modification on the existing medium plates 140.

The second mode is reducing the quantity of the antenna units in the medium plate 140. However, with the decreasing of the quantity of the antenna units, the gain of the omnidirectional antenna 1000 decreases accordingly.

The third mode is adding a bent reflecting plate. However, the adding of the bent reflecting plate causes the structure of the omnidirectional antenna 1000 to be more complicated, and increases the size and the cost of the omnidirectional antenna 1000.

Therefore, how to, while ensuring a substantially unchanged gain of the omnidirectional antenna 1000, increase the beam width of the omnidirectional antenna 1000, and take into consideration the characteristics of a compact structure, a low cost and a low structural difference from the existing omnidirectional antennas 1000, has become a technical problem required to be solved urgently.

In view of the above, in the embodiments of the present disclosure a parasitic branch 20 is provided at the upper taper oscillator 120 and/or the lower taper oscillator 130, to increase the beam width of the omnidirectional antenna 1000 by using the parasitic branch 20. The cases in which the parasitic branch 20 is provided at the upper taper oscillator 120 or the lower taper oscillator 130 will be described below individually.

Firstly, the case in which the parasitic branch 20 is provided at the upper taper oscillator 120 will be described. The parasitic branch 20 is electrically connected to the upper taper oscillator 120 and protrudes out of the outer surface of the upper taper oscillator 120. The parasitic branch 20 is made from a conductor, and the electric current flows in the upper taper oscillator 120, passes through the parasitic branch 20, and subsequently flows back to the upper taper oscillator 120 from the parasitic branch 20, to form a closed loop. Because of the closed loop, the current path is lengthened, the current distribution becomes more uniform, and the weak-current area is covered, which affects the fusing of the directional diagram of the horizontally polarized radiation, thereby widening the beam width of the horizontally polarized antenna.

In practical applications, the parasitic branch 20 may be fabricated by integral formation with the upper taper oscillator 120; for example, the upper taper oscillator 120 having the parasitic branch 20 is fabricated by casting, stamping and so on. The parasitic branch 20 may also be connected to the upper taper oscillator 120; for example, the parasitic branch 20 is connected to the upper taper oscillator 120 by riveting, snap fitting, welding, screw connection and so on. The connection mode between the parasitic branch 20 and the upper taper oscillator 120 is not limited in the embodiments of the present disclosure.

The material of the parasitic branch 20 may be the same as that of the upper taper oscillator 120, and may also be different from that of the upper taper oscillator 120. As an example, the parasitic branch 20 may be made from a metal, for example, aluminum, copper and silver.

The parasitic branch 20 may have various shapes, which may be sheet-like, columnar and so on, as long as the parasitic branch 20 protrudes out of the outer surface of the upper taper oscillator 120.

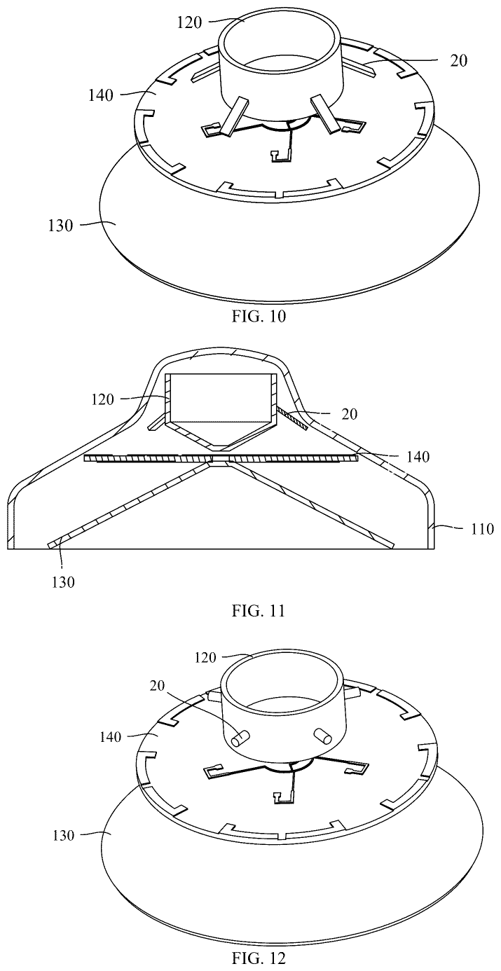

FIG. 10 illustratively shows a partially schematic structural diagram of an omnidirectional antenna 1000. In order to facilitate the illustration, FIG. 10 does not show the components such as the antenna housing 110 of the omnidirectional antenna 1000. FIG. 11 illustratively shows a sectional view of an omnidirectional antenna 1000. As an example, as shown in FIGS. 10 and 11, the parasitic branch 20 is overall sheet-like, one end of the parasitic branch 20 is connected to the upper taper oscillator 120, and the other end of the parasitic branch 20 extends in the direction further away from the upper taper oscillator 120.

FIG. 12 illustratively shows a partially schematic structural diagram of an omnidirectional antenna 1000. In order to facilitate the illustration, FIG. 12 does not show the components such as the antenna housing 110 of the omnidirectional antenna 1000. As an example, as shown in FIG. 12, the parasitic branch 20 is overall of a columnar shape, one end of the parasitic branch 20 is connected to the upper taper oscillator 120, and the other end of the parasitic branch 20 extends in the direction further away from the upper taper oscillator 120.

The end of the parasitic branch 20 away from the upper taper oscillator 120 may incline toward the medium plate 140, to cause the parasitic branch 20 and the medium plate 140 to have a lower distance, which increases the influence by the parasitic branch 20 on the fusing of the directional diagram of the horizontally polarized radiation, thereby widening the beam width of the horizontally polarized antenna. In addition, the inclining of the parasitic branch 20 toward the medium plate 140 can reduce the circumferential dimension after the parasitic branch 20 has been connected to the upper taper oscillator 120, thereby reducing the size of the antenna housing 110, whereby the omnidirectional antenna 1000 has a more compact structure.

The parasitic branch 20 may incline toward the medium plate 140 in various modes. The parasitic branch 20 may be overall of a straight line shape, and the straight-line-shaped parasitic branch 20 and the outer surface of the upper taper oscillator 120 have a certain included angle, wherein the inclining mode of the parasitic branch 20 is shown in FIGS. 10 and 11. The parasitic branch 20 may also be overall of a folded line shape; in other words, the parasitic branch 20 includes a first section connected to the upper taper oscillator 120 and a second section extending toward the medium plate 140, and the first section and the second section have a certain included angle therebetween.

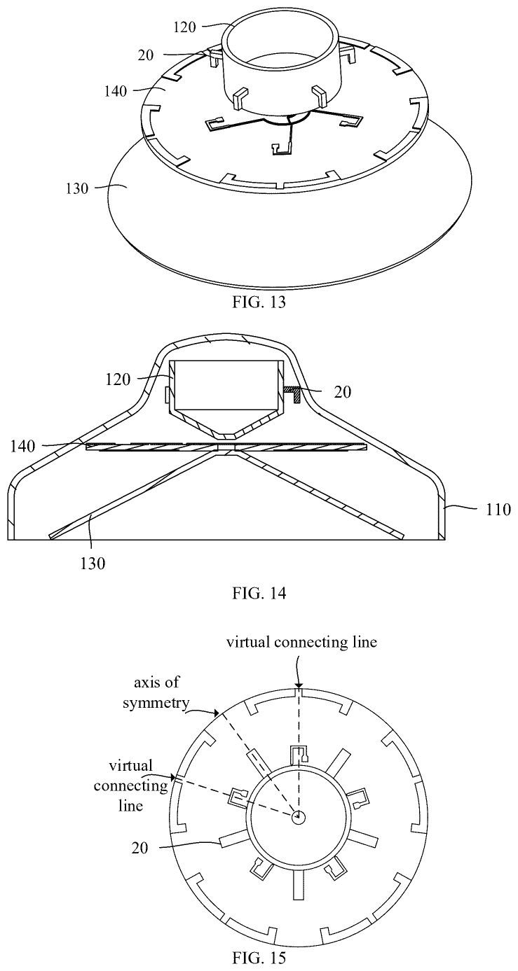

FIG. 13 illustratively shows a partially schematic structural diagram of an omnidirectional antenna 1000. In order to facilitate the illustration, FIG. 13 does not show the components such as the antenna housing 110 of the omnidirectional antenna 1000. FIG. 14 illustratively shows a sectional view of an omnidirectional antenna 1000. As an example, as shown in FIGS. 13 and 14, the first section of the parasitic branch 20 extends in the second direction X, and the second section of the parasitic branch 20 extends in the first direction Y.

Referring continuously to FIGS. 10 to 14, the upper taper oscillator 120 may be provided with a plurality of parasitic branches 20, and the plurality of parasitic branches 20 are arranged separately in the circumferential direction of the upper taper oscillator 120, which causes the influence by the parasitic branches 20 on the horizontally polarized radiation to be more uniform, thereby increasing the circularity of the directional diagram of the horizontally polarized radiation.

As an example, if the projection of the upper taper oscillator 120 on the medium plate 140 is a circle, the plurality of parasitic branches 20 are arranged in a circular array around the upper taper oscillator 120.

FIG. 15 illustratively shows a top view of a partially structure an omnidirectional antenna 1000. As shown in FIG. 15, the direction of extension of a virtual connecting line between the antenna unit and the center of the circular array is a second direction, and the direction of extension of the axis of symmetry of two neighboring virtual connecting lines is a third direction.

The orthographic projection of the parasitic branch 20 on the medium plate 140 extends in the second direction or the third direction, and a plurality of parasitic branches 20 are arranged evenly in the circumferential direction of the upper taper oscillator 120 or the lower taper oscillator 130, so as to prevent deteriorating the circularity of the directional diagram of the horizontally polarized radiation.

The quantity of the parasitic branches 20 is n times or 1/n times the quantity of the antenna units, wherein n is a natural number and n≥1. The quantity of the parasitic branch 20 is n times or 1/n times the quantity of the antenna unit, which can prevent deteriorating the circularity of the directional diagram of the horizontally polarized radiation. The quantity of the parasitic branches 20 may be increased or reduced according to demands, to realize regulating the beam width of the omnidirectional antenna 1000. The size of the parasitic branch 20 may be regulated according to the working frequency of the omnidirectional antenna 1000, the size of the antenna housing 110, the requirement on the beam width, and so on. For example, a horizontally polarized omnidirectional antenna 1000 operates at 2.5-2.7 GHz, and therefore the size of the parasitic branch 20 should not be too low, or else it has no effect of uniformizing the current distribution. Moreover, the size of the parasitic branch 20 should be restricted inside the antenna housing 110. By reasonably configuring the size of the parasitic branch 20, the current path is lengthened, and the weak-current area is covered, thereby widening the beam width of the horizontally polarized antenna.

For example, the quantity of the antenna units is six, and accordingly the quantity of the parasitic branches 20 may be two, three, six, twelve and so on. As another example, the quantity of the antenna units is five, and accordingly the quantity of the parasitic branches 20 may be five, ten, fifteen and so on.

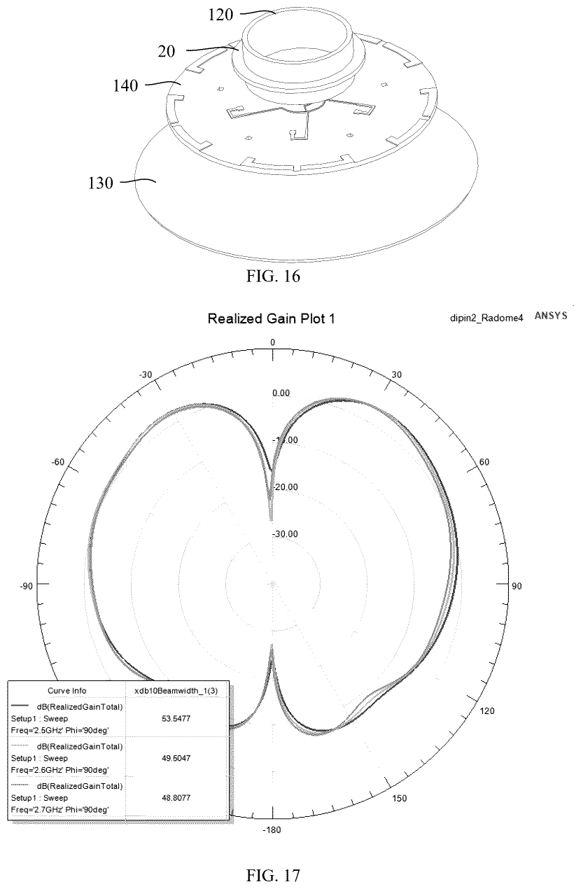

FIG. 16 illustratively shows a schematic diagram of an omnidirectional antenna 1000. As shown in FIG. 16, the parasitic branch 20 may be of a round-ring shape, and the parasitic branch 20 is nested to the outer surface of the upper taper oscillator 120. The round-ring-shaped parasitic branch 20 can prevent deteriorating the circularity of the directional diagram of the horizontally polarized radiation. If the parasitic branch 20 is of a round-ring shape, the end of the parasitic branch 20 away from the upper taper oscillator 120 may incline toward the medium plate 140.

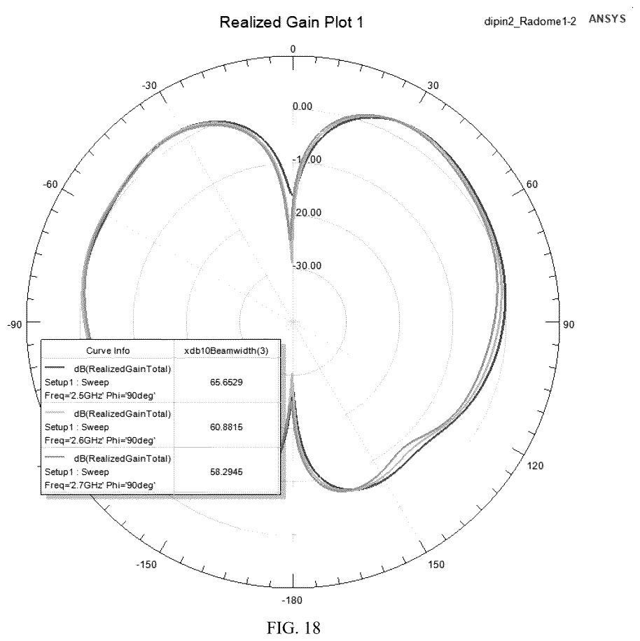

FIG. 17 shows a simulation diagram of the radiation directions of an omnidirectional antenna 1000 not provided with the parasitic branch 20. FIG. 18 shows a simulation diagram of the radiation directions of the omnidirectional antenna 1000 shown in FIG. 10. As shown in FIG. 17, when the parasitic branch 20 is not provided, the beam width of the horizontally polarized radiation is approximately 48.8°. As shown in FIG. 18, when the upper taper oscillator 120 is provided with the parasitic branch 20, the beam width of the horizontally polarized radiation is approximately 58.3°. Accordingly, it can be known that, by providing the parasitic branch 20 at the upper taper oscillator 120, the beam width of the horizontally polarized radiation is increased by approximately 10°.

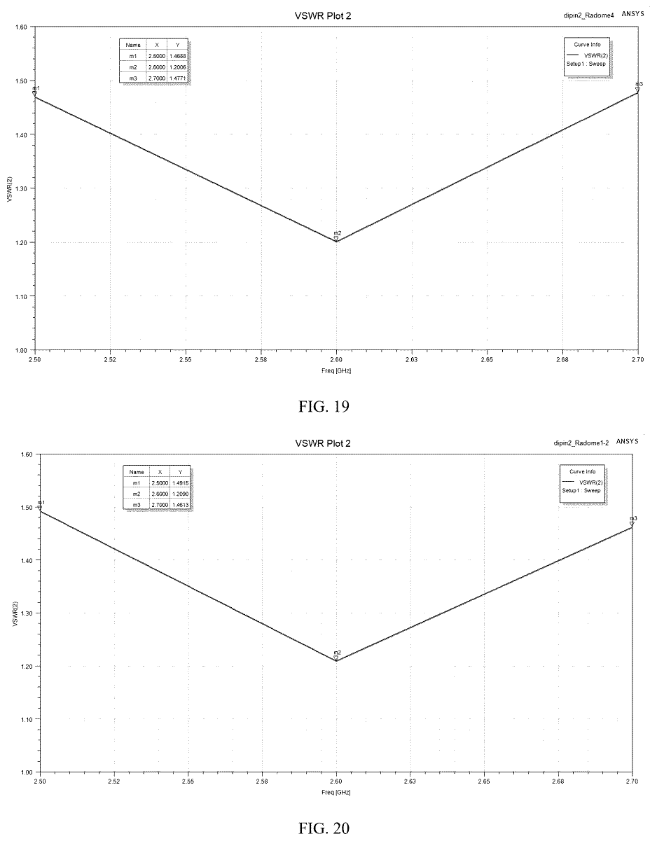

FIG. 19 shows a standing wave of an omnidirectional antenna 1000 not provided with the parasitic branch 20. FIG. 20 shows a standing wave of the omnidirectional antenna 1000 shown in FIG. 10. As shown in FIGS. 19 and 20, both of the standing waves when the parasitic branch 20 is not provided and when the parasitic branch 20 is provided are below 1.5, and the omnidirectional antennas 1000 are matched well.

Referring continuously to FIG. 11, the upper taper oscillator 120 includes a taper face and a columnar face connected to the end of the taper face away from the lower taper oscillator 130, and the parasitic branch 20 may be connected to the columnar face. By providing the parasitic branch 20 at the columnar face, the current distribution is more uniform, which affects the fusing of the directional diagram of the horizontally polarized radiation.

As an example, in the first direction Y, the parasitic branch 20 is located at the middle part of the upper taper oscillator 120, or the tip of the parasitic branch 20 away from the upper taper oscillator 120 extends to the middle part or a lower position of the upper taper oscillator 120, thereby having an influence on the fusing of the directional diagram of the horizontally polarized radiation.

The case in which the parasitic branch 20 is provided at the lower taper oscillator 130 will be described below. The parasitic branch 20 is electrically connected to the lower taper oscillator 130 and protrudes out of the outer surface of the lower taper oscillator 130. The parasitic branch 20 is made from a conductor, and the electric current flows in the lower taper oscillator 130, passes through the parasitic branch 20, and subsequently flows back to the lower taper oscillator 130 from the parasitic branch 20, to form a closed loop. Because of the closed loop, the current path is lengthened, the current distribution becomes more uniform, and the weak-current area is covered, which affects the fusing of the directional diagram of the horizontally polarized radiation, thereby widening the beam width of the horizontally polarized antenna.

In practical applications, the parasitic branch 20 may be fabricated by integral formation with the lower taper oscillator 130; for example, the lower taper oscillator 130 having the parasitic branch 20 is fabricated by casting, stamping and so on. The parasitic branch 20 may also be connected to the lower taper oscillator 130; for example, the parasitic branch 20 is connected to the lower taper oscillator 130 by riveting, snap fitting, welding, screw connection and so on. The connection mode between the parasitic branch 20 and the lower taper oscillator 130 is not limited in the embodiments of the present disclosure.

The material of the parasitic branch 20 may be the same as that of the lower taper oscillator 130, and may also be different from that of the lower taper oscillator 130. As an example, the parasitic branch 20 may be made from a metal, for example, aluminum, copper and silver.

The parasitic branch 20 may have various shapes, which may be sheet-like, columnar and so on, as long as the parasitic branch 20 protrudes out of the outer surface of the lower taper oscillator 130.

There may be a plurality of parasitic branches 20. The direction of extension of a virtual connecting line between the antenna unit and the center of the circular array is a second direction, and the direction of extension of the axis of symmetry of two neighboring virtual connecting lines is a third direction. The orthographic projection of the parasitic branch 20 on the medium plate 140 extends in the second direction or the third direction, and a plurality of parasitic branches 20 are arranged evenly in the circumferential direction of the upper taper oscillator 120 or the lower taper oscillator 130, so as to prevent deteriorating the circularity of the directional diagram of the horizontally polarized radiation.

The quantity of the parasitic branches 20 is n times or 1/n times the quantity of the antenna units, wherein n is a natural number and n≥1. The quantity of the parasitic branch 20 is n times or 1/n times the quantity of the antenna unit, which can prevent deteriorating the circularity of the directional diagram of the horizontally polarized radiation. The quantity of the parasitic branches 20 may be increased or reduced according to demands, to realize regulating the beam width of the omnidirectional antenna 1000. The size of the parasitic branch 20 may be regulated according to the working frequency of the omnidirectional antenna 1000, the size of the antenna housing 110, the requirement on the beam width, and so on. For example, a horizontally polarized omnidirectional antenna 1000 operates at 2.5-2.7 GHz, and therefore the size of the parasitic branch 20 should not be too low, or else it has no effect of uniformizing the current distribution. Moreover, the size of the parasitic branch 20 should be restricted inside the antenna housing 110. By reasonably configuring the size of the parasitic branch 20, the current path is lengthened, and the weak-current area is covered, thereby widening the beam width of the horizontally polarized antenna.

For example, the quantity of the antenna units is six, and accordingly the quantity of the parasitic branches 20 may be two, three, six, twelve and so on. As another example, the quantity of the antenna units is five, and accordingly the quantity of the parasitic branches 20 may be five, ten, fifteen and so on.

The first end of the parasitic branch 20 is connected to the lower taper oscillator 130, and the second end of the parasitic branch 20 may be connected to and fixed to the medium plate 140, thereby preventing deviation of the relative position between the medium plate 140 and the lower taper oscillator 130, which affects the performance of the omnidirectional antenna 1000.

When the medium plate 140 and the lower taper oscillator 130 are fixed, a hollow region 140a is provided at the position of the medium plate 140 that corresponds to the taper vertex, and the first end of the fixing tube 160 may be inserted into the hollow region 140a and fixedly connected to the medium plate 140, thereby realizing the connection of the upper taper oscillator 120, the fixing tube 160, the medium plate 140 and the lower taper oscillator 130.

As an example, the size of the hollow region 140a is slightly less than the size of the first end of the fixing tube 160, so that the first end of the fixing tube 160 is interference-fitted to the medium plate 140.

The parasitic branch 20 and the medium plate 140 may be connected in various modes.

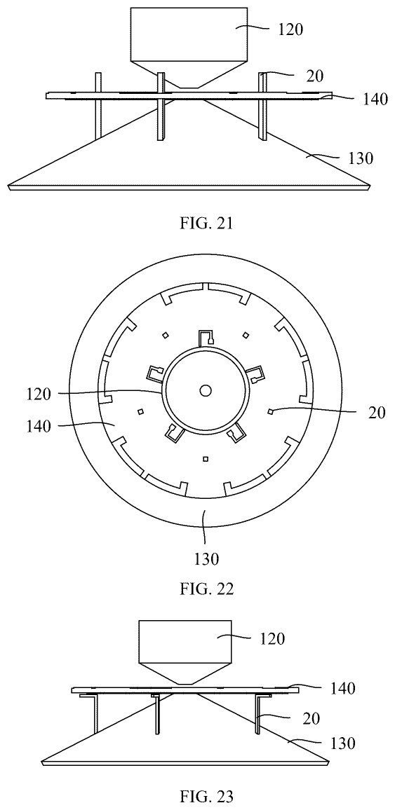

FIG. 21 illustratively shows a partially structural diagram of an omnidirectional antenna 1000. FIG. 22 is a top view of FIG. 21. As shown in FIGS. 21 and 22, the medium plate 140 is provided with a mounting hole, and the second end of the parasitic branch 20 penetrates the mounting hole.

FIG. 23 illustratively shows a partially structural diagram of an omnidirectional antenna 1000. As shown in FIG. 23, the parasitic branch 20 is located on the side of the medium plate 140 that faces the lower taper oscillator 130, one end of the parasitic branch 20 is connected to the lower taper oscillator 130, and the other end of the parasitic branch 20 is connected to the side of the medium plate 140 that faces the lower taper oscillator 130.

Certainly, the parasitic branch 20 may also not be connected to the medium plate 140, which is not limited in the embodiments of the present disclosure.

It should be noted that the shape of the parasitic branch 20 is not limited to the shapes shown in the above-described figures, and the parasitic branch 20 may also be of a wave shape, a conical shape, a prismatic shape and so on.

### The Second Embodiment

FIG. 2 is a view in the direction A of the omnidirectional antenna 1000 in FIG. 1. FIG. 3 is a sectional view along B-B in FIG. 2. As shown in FIGS. 2 and 3, the omnidirectional antenna 1000 may include an antenna housing 110, and a medium plate 140 provided inside the antenna housing 110.

Referring continuously to FIG. 3, the medium plate 140 is perpendicular to the first direction Y; in other words, the plane where the medium plate 140 is located extends in the second direction X. The medium plate 140 may have various positions in the first direction Y. For example, the medium plate 140 may be located between the upper taper oscillator 120 and the lower taper oscillator 130, the medium plate 140 may also be located on the side of the lower taper oscillator 130 away from the upper taper oscillator 120, and the medium plate 140 may also be located on the side of the upper taper oscillator 120 away from the lower taper oscillator 130. In practical applications, in order to reduce the size of the omnidirectional antenna 1000, the medium plate 140 may be located between the upper taper oscillator 120 and the lower taper oscillator 130, or the medium plate 140 is located on the side of the lower taper oscillator 130 away from the upper taper oscillator 120.

If the medium plate 140 is located between the upper taper oscillator 120 and the lower taper oscillator 130, a hollow region 140a is provided at the position of the medium plate 140 that corresponds to the taper vertex, and the hollow region 140a extends throughout the medium plate 140 in the first direction Y. The core wire 1 may penetrate the hollow region 140a and be electrically connected to the upper taper oscillator 120.

As an example, the medium plate 140 is of a circular shape, and the circle-center region of the medium plate 140 is the hollow region 140a.

FIG. 9 illustratively shows a sectional view of a medium plate 140. As shown in FIG. 9, the medium plate 140 may include a first electrically conducting layer 142, a second electrically conducting layer 143 and a medium base board 141 located between the first electrically conducting layer 142 and the second electrically conducting layer 143.

The medium base board 141 may be a glass base board, a polytetrafluoroethylene glass-fiber press plate, an epoxy-resin base board, a polyimide base board and so on, and the material of the medium base board 141 is not limited in the embodiments of the present disclosure. The first electrically conducting layer 142 and the second electrically conducting layer 143 are made from a conductor, for example, aluminum, copper, silver and gold. The first electrically conducting layer 142 covers one side of the medium base board 141, and the second electrically conducting layer 143 covers the opposite side of the medium base board 141.

As an example, the medium plate 140 is fabricated by using a Printed Circuit Board (referred to for short as PCB) process.

The first electrically conducting layer 142 includes a radiating component, the second electrically conducting layer 143 includes an earthing component 50, and the radiating component, the earthing component 50 and the medium base board 141 located between the radiating component and the earthing component 50 form an antenna unit. The antenna unit is configured to form horizontally polarized radiation.

The first electrically conducting layer 142 may include a plurality of radiating components, and the plurality of radiating components surround the taper vertex and are arranged in a circular array. Each of the radiating components forms one antenna unit with the earthing component 50 and the medium base board 141, whereby the medium plate 140 includes a plurality of antenna units, and the plurality of antenna units form an antenna array.

As an example, if the medium plate 140 is of a circular shape, the plurality of radiating components are arranged in an array along the edge of the medium plate 140.

The antenna unit may be a patch antenna unit, and may also be a dipole antenna unit. If the antenna unit is a patch antenna unit, the radiating components are radiating patches, and the shape of the radiating patches may be a circle, an ellipse, a polygon such as a rectangle and a triangle, and an irregular shape, which is not limited in the embodiments of the present disclosure. If the antenna unit is a dipole antenna unit, the radiating components are radiating dipoles 10. Merely the case is taken as an example for exemplary illustration below in which the antenna unit is a dipole antenna unit.

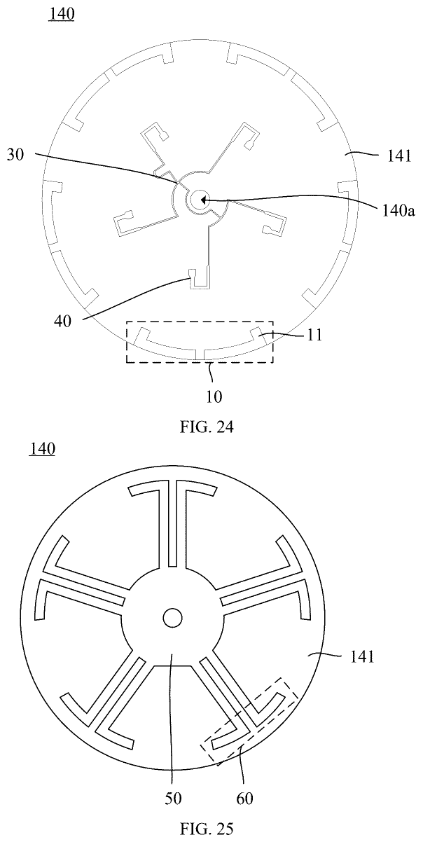

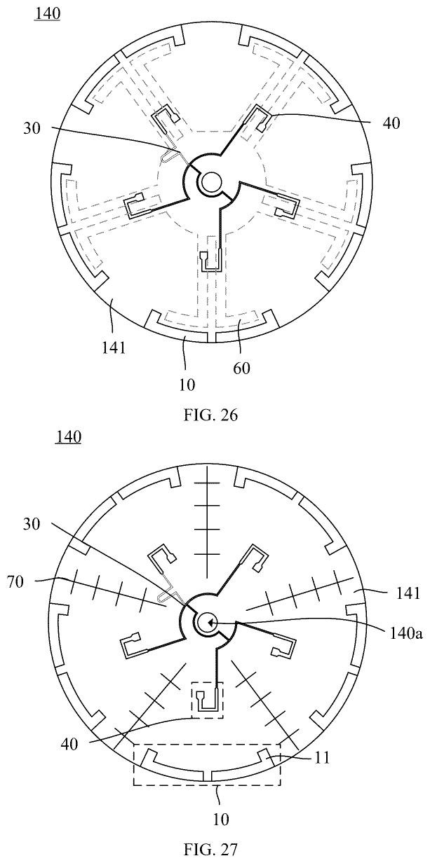

FIG. 24 illustratively shows a front view of a medium plate 140. FIG. 25 illustratively shows a back view of a medium plate 140. FIG. 26 illustratively shows a perspective view of a medium plate 140. FIG. 26 shows a schematic diagram when the medium plate 140 is in a transparent state, wherein the solid-line part in the figure illustrates the front-face structure of the medium plate 140, the dotted-line part in the figure illustrates the back-face structure of the medium plate 140, and FIG. 26 shows the relative position relation between the front-face structure and the back-face structure.

What is located at the front face of the medium plate 140 may be the first electrically conducting layer 142, and what is located at the back face of the medium plate 140 may be the second electrically conducting layer 143. As an example, the front face of the medium plate 140 refers to the face of the medium plate 140 that faces the upper taper oscillator 120, and the back face of the medium plate 140 refers to the face of the medium plate 140 that faces the lower taper oscillator 130.

As shown in FIG. 24, the first electrically conducting layer 142 includes a plurality of radiating components, each of the radiating components includes a radiating dipole 10, the radiating dipole 10 includes two electrically conducting arms that are symmetrically provided, and the two electrically conducting arms are separate. As shown in FIG. 11, the second electrically conducting layer 143 includes an earthing component 50. The radiating component, the earthing component 50 and the medium base board 141 located between the radiating component and the earthing component 50 form an antenna unit.

As an example, each of the electrically conducting arms is of a circular-arc shape. If the medium plate 140 is of a circular shape, the electrically conducting arms extend along the edge of the medium plate 140. Certainly, the electrically conducting arms may also be of another shape, for example, a straight-line shape.

As an example, the second electrically conducting layer 143 is patterned to form a circular earthing component 50. Certainly, the second electrically conducting layer 143 may also not be patterned, and the entire second electrically conducting layer 143 serves as the earthing component 50.

Referring continuously to FIG. 24, the first electrically conducting layer 142 may further include a power divider 30, the power divider 30 includes a plurality of output terminals, and the different radiating dipoles 10 are electrically connected to the different output terminals. The power divider 30 is configured to distribute signals to the plurality of radiating dipoles 10.

As an example, referring continuously to FIG. 24 and FIG. 25, the first electrically conducting layer 142 further includes electricity-feeding baluns 40, each of the output terminals of the power divider 30 is connected to one of the electricity-feeding baluns 40, and the electricity-feeding baluns 40 correspond to the radiating dipoles 10 one to one. The second electrically conducting layer 143 further includes a complementary dipole 60, the complementary dipole 60 is electrically connected to the earthing component 50, and the orthographic projection on the medium base board 141 of the radiating dipole 10 and the orthographic projection on the medium base board 141 of the complementary dipole 60 do not overlap. In this case, the radiating dipole 10, the complementary dipole 60, the electricity-feeding balun 40, the earthing component 50 and the medium base board 141 form one antenna unit.

FIG. 24 to FIG. 26 show the case in which the medium plate 140 includes five antenna units; in other words, the medium plate 140 includes five radiating dipoles 10, five complementary dipoles 60, five electricity-feeding baluns 40 and one earthing component 50, and the power divider 30 is of a one-divided-into-five structure. As the medium plate 140 includes five antenna units, the included angle between two neighboring antenna units is 72°. It should be noted that the quantity of the antenna units included by the medium plate 140 is not limited thereto, the quantity of the antenna units may also be three, four, six and so on, and the included angle between two neighboring antenna units adaptively varies.

Referring continuously to FIG. 24, each of the two opposite ends of the radiating dipole 10 includes a bending part extending toward the center of the circular array; in other words, both of the two opposite ends of two electrically conducting arms are provided with the bending part. The bending parts can improve the standing wave of the omnidirectional antenna 1000.

In order to improve the indoor wireless-communication quality, the omnidirectional antenna 1000 is required to have a high gain and a wide beam width, to ensure providing a high-quality and high-stability coverage in the complicated indoor environment. In order to solve that problem, the following several modes are usually employed in the related art:
the first mode is increasing the quantity (i.e., increasing the quantity of the antenna units) and the size of the radiating dipoles 10. However, with the increasing of the quantity of the radiating dipoles 10, the beam width of the omnidirectional antenna 1000 decreases to a large extent, and the size of the medium plate 140 requires being increased with the increasing of the quantity and the size of the radiating dipoles 10.

The second mode is using radiating dipoles 10 having a high gain. However, the radiating dipoles 10 having a high gain have complicated structures, and require modifying the structures of the existing omnidirectional antennas 1000 to a large extent, which increases the fabrication cost of the omnidirectional antenna 1000.

The third mode is providing reflectors around the radiating dipoles 10. However, the provision of the reflectors causes a complicated structure of the omnidirectional antenna 1000, and the thickness of the medium plate 140 in the first direction Y is increased.

Therefore, how to, while ensuring a wide beam width of the omnidirectional antenna 1000, increase the gain of the omnidirectional antenna 1000, and cause the omnidirectional antenna 1000 to at the same time have the characteristics of a compact structure, a low cost and a as small as possible modification on the medium plate 140, has become a problem required to be solved urgently.

FIG. 27 illustratively shows a structural diagram of a medium plate 140. As shown in FIG. 27, the omnidirectional antenna 1000 further includes a gain branch 70, the gain branch 70 is connected to the side of the medium base board 141 that faces the first electrically conducting layer 142, the gain branch 70 is located between two neighboring radiating components, and the gain branch 70 is made from a conductor and is separate from the radiating components.

The gain branch 70 can reduce the electric-current dissipation, to reduce the coupling between two neighboring radiating components, thereby increasing the gain of the omnidirectional antenna 1000. Furthermore, the gain branch 70 may be considered as one edge of the radiating component, whereby the gain branch 70 can improve the directivity of the antenna unit, thereby increasing the gain of the omnidirectional antenna 1000.

The gain branch 70 may be provided between each two neighboring radiating components, thereby improving the radiation evenness in all the directions of the omnidirectional antenna 1000. As an example, referring continuously to FIG. 27, the medium plate 140 includes five radiating components and five gain branches 70, the five radiating components are arranged in a circular array, and the gain branches 70 are provided between each two neighboring radiating components.

The gain branch 70 extends in the radial direction of the circular array, and the two neighboring radiating components of the gain branch 70 is symmetrical with respect to the gain branch 70, thereby further improving the radiation evenness in all the directions of the omnidirectional antenna 1000. The radial direction of the circular array refers to the direction in the plane where the medium plate 140 is located from the circle center of the circular array pointing to the outer side.

As an example, the gain branch 70 is overall elongate, one end of the gain branch 70 points to the circle center of the circular array, and the other end of the gain branch 70 is located between two neighboring radiating components, and extends in the direction further away from the circle center of the circular array.

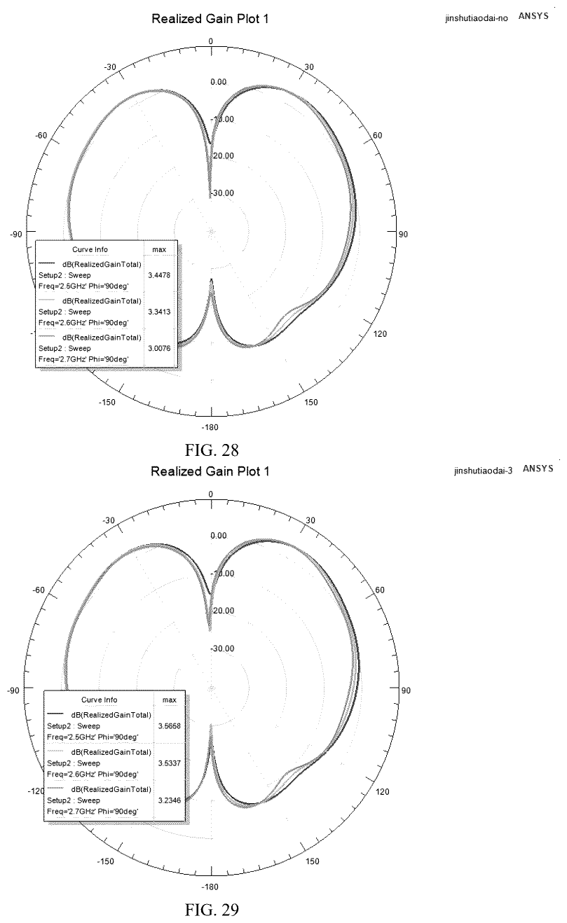

FIG. 28 shows a simulation diagram of the radiation directions of an omnidirectional antenna 1000 including the medium plate 140 shown in FIG. 26. As shown in FIG. 28, the gain in the simulation diagram of the radiation directions of the omnidirectional antenna 1000 is 3 dBi. FIG. 29 shows a simulation diagram of the radiation directions of an omnidirectional antenna 1000 including the medium plate 140 shown in FIG. 27. As shown in FIG. 29, the gain in the simulation diagram of the radiation directions of the omnidirectional antenna 1000 is 3.23 dBi. In other words, as compared with the case in which the gain branch 70 is not provided, after the gain branch 70 is provided the gain of the omnidirectional antenna 1000 is increased by 0.23 dBi.

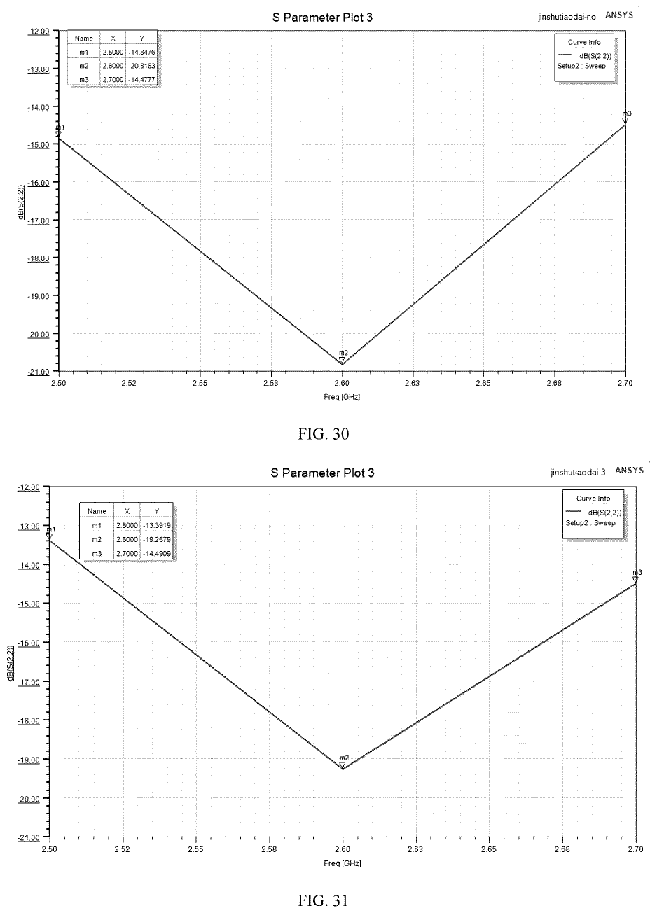

FIG. 30 shows a diagram of the S parameter of an omnidirectional antenna 1000 including the medium plate 140 shown in FIG. 26. FIG. 31 shows a diagram of the S parameter of an omnidirectional antenna 1000 including the medium plate 140 shown in FIG. 27. As shown in FIGS. 30 and 31, both of the reflection coefficients of the two omnidirectional antennas 1000 are below −10 dB; in other words, the omnidirectional antennas 1000 are matched well.

The gain branch 70 may be located inside the first electrically conducting layer 142, and may also be connected to the side of the medium base board 141 that faces the first electrically conducting layer 142 and protrude out of the first electrically conducting layer 142 in the first direction.

Firstly, several optional structures of the gain branch 70 when the gain branch 70 is located at the first electrically conducting layer 142 will be described.

Referring continuously to FIG. 27, in FIG. 27 the gain branch 70 is of a “double E” shape, and includes a main body 3 extending in the radial direction of the circular array and a plurality of branches 4 connected to the main body 3, and the plurality of branches 4 are arranged separately in the radial direction of the circular array.

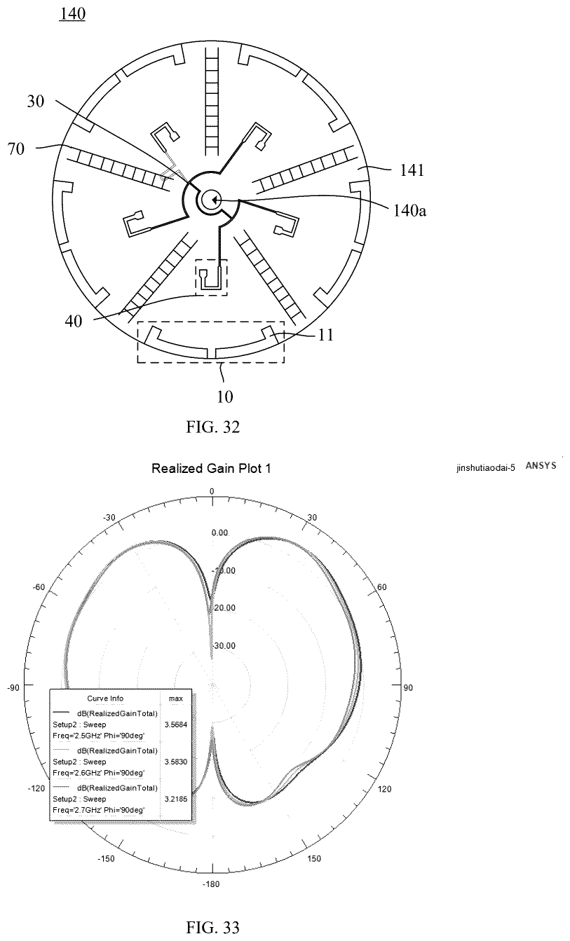

FIG. 32 illustratively shows a structural diagram of another medium plate 140. In FIG. 32 the gain branch 70 is of a ladder shape, and includes two main bodies 3 extending in the radial direction of the circular array and a plurality of branches 4 connected to the two main bodies 3, and the plurality of branches 4 are arranged separately in the radial direction of the circular array. FIG. 33 shows a simulation diagram of the radiation directions of an omnidirectional antenna 1000 including the medium plate 140 shown in FIG. 32. As shown in FIG. 33, the gain of the omnidirectional antenna 1000 is 3.22 dBi, and, as compared with the case in which the gain branch 70 is not provided in FIG. 26, the gain is increased by 0.22 dBi.

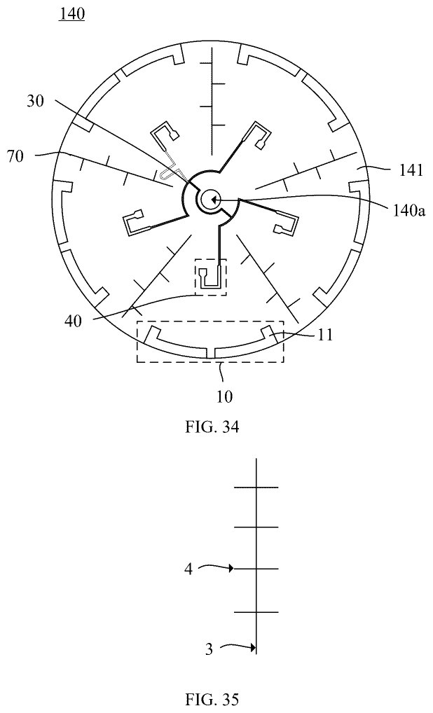

FIG. 34 illustratively shows a structural diagram of another medium plate 140. The gain branch 70 in FIG. 34 includes a main body 3 extending in the radial direction of the circular array and a plurality of branches 4 connected to the main body 3, the plurality of branches 4 are arranged separately in the radial direction of the circular array, and the plurality of branches 4 located on the two sides of the main body 3 are distributed in stagger.

It can be known from FIG. 27, FIG. 32 and FIG. 34 that the gain branch 70 may include a main body 3 extending in the radial direction of the circular array and a plurality of branches 4 connected to the main body 3, and the plurality of branches 4 are arranged separately in the radial direction of the circular array. The main body 3 may be a plurality of main bodies 3, and the branches 4 located on the two sides of the main bodies 3 may be aligned, and may also be in stagger. FIG. 35 shows a structural diagram of the gain branch 70 of the medium plate 140 shown in FIG. 27. Taking the structure of the gain branch 70 in FIG. 35 as an example, the longer component of the gain branch 70 is the main body 3, and the shorter components are the branches 4.

In addition, all of the main bodies 3 shown in FIG. 27, FIG. 32 and FIG. 34 are in a straight line shape. In practical applications, the main body 3 may also be of a rectangle, a prismatic shape, a trapezoid, a wave shape or an irregular shape.

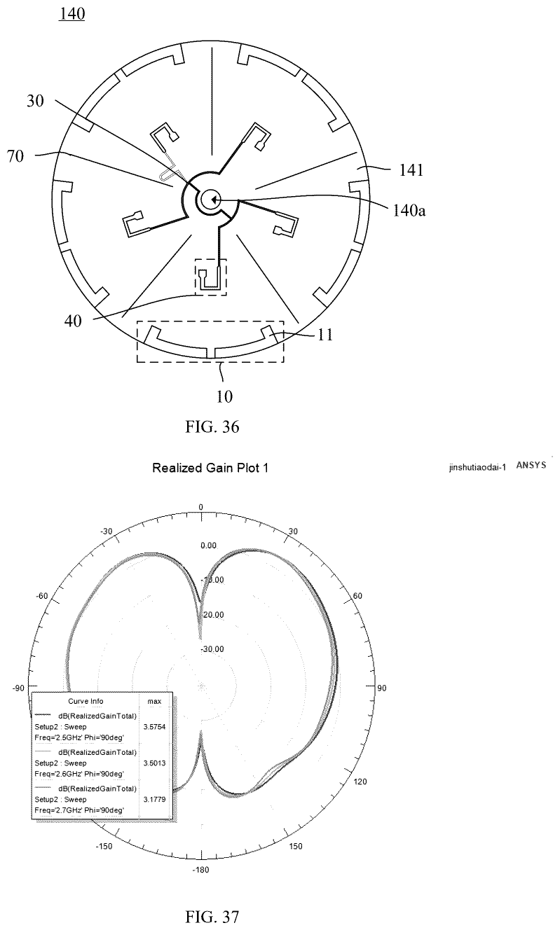

FIG. 36 illustratively shows a structural diagram of another medium plate 140. The gain branch 70 in FIG. 36 merely includes a main body 3 extending in the radial direction of the circular array. FIG. 37 shows a simulation diagram of the radiation directions of an omnidirectional antenna 1000 including the medium plate 140 shown in FIG. 36. As shown in FIG. 37, the gain of the omnidirectional antenna 1000 is 3.18 dBi, and, as compared with the case in which the gain branch 70 is not provided in FIG. 26, the gain is increased by 0.18 dBi.

The gain branch 70 may include a plurality of gain sub-branches, and the plurality of gain sub-branches in the same gain branch 70 are arranged separately in the circumferential direction of the circular array.

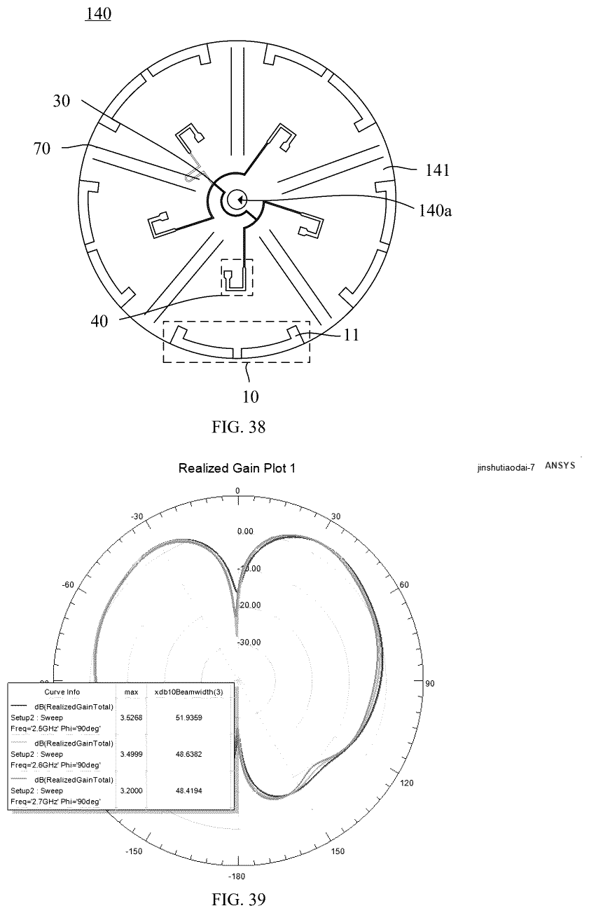

FIG. 38 illustratively shows a structural diagram of another medium plate 140. The gain branch 70 in FIG. 38 includes two gain sub-branches, the gain sub-branches extend in the radial direction of the circular array, and the two gain sub-branches are arranged separately in the circumferential direction of the circular array. FIG. 39 shows a simulation diagram of the radiation directions of an omnidirectional antenna 1000 including the medium plate 140 shown in FIG. 38. As shown in FIG. 39, the gain of the omnidirectional antenna 1000 is 3.2 dBi, and, as compared with the case in which the gain branch 70 is not provided in FIG. 27, the gain is increased by 0.2 dBi.

The axis of symmetry of two neighboring radiating components is a first axis of symmetry, and if the plurality of gain sub-branches in the same gain branch 70 are arranged separately in the circumferential direction of the circular array, the plurality of gain sub-branches in the same gain branch 70 are symmetrical with respect to the first axis of symmetry.

If the gain branch 70 includes a plurality of gain sub-branches, the plurality of gain sub-branches in the same gain branch 70 may also be arranged separately in the radial direction of the circular array.

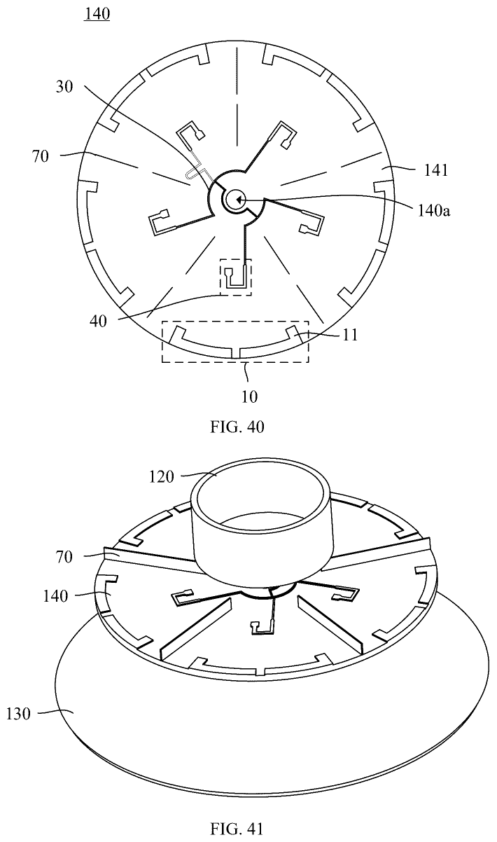

FIG. 40 illustratively shows a structural diagram of another medium plate 140. The gain branch 70 in FIG. 40 includes two gain sub-branches, the gain sub-branches extend in the radial direction of the circular array, and the two gain sub-branches are arranged separately in the radial direction of the circular array.

The length of the gain branch 70 in the radial direction of the circular array may be regulated according to practical demands.

The end of the gain branch 70 away from the center of the circular array may face the bending part, so that the gain branch 70 and the radiating dipole 10 have a low distance. The radiating dipole 10 may energize the gain branch 70, so that the gain branch 70 generates radiation.

The end of the gain branch 70 that faces the center of the circular array may extend to the earthing component 50, thereby facilitating the electric connection between the gain branch 70 and the earthing component 50. For example, if the first electrically conducting layer 142 includes the radiating dipole 10, and the second electrically conducting layer 143 includes the complementary dipole 60 and the earthing component 50, the gain branch 70 is electrically connected to the earthing component 50. As an example, the medium base board 141 is provided with a through hole, and part of the structure of the gain branch 70 is electrically connected to the earthing component 50 via the through hole.

As an example, the end of the gain branch 70 away from the center of the circular array extends to the edge of the medium plate 140.

Several optional structures of the gain branch 70 when the gain branch 70 is connected to the side of the medium base board 141 that faces the first electrically conducting layer 142 and protrudes out of the first electrically conducting layer 142 in the first direction will be described below.

The gain branch 70 may be sheet-like, one end of the gain branch 70 is connected to the side of the medium base board 141 that faces the first electrically conducting layer 142, and the other end of the gain branch 70 extends in the direction further away from the medium base board 141. As an example, the gain branch 70 is perpendicularly connected to the medium base board 141.

FIG. 41 illustratively shows a partially structural diagram of an omnidirectional antenna 1000. As an example, as shown in FIG. 41, the gain branch 70 is overall rectangular, and the gain branch 70 includes two longer sides and two shorter sides, wherein one of the longer sides is connected to the medium base board 141 and extends in the radial direction of the circular array, and the shorter sides are perpendicular to the medium base board 141.

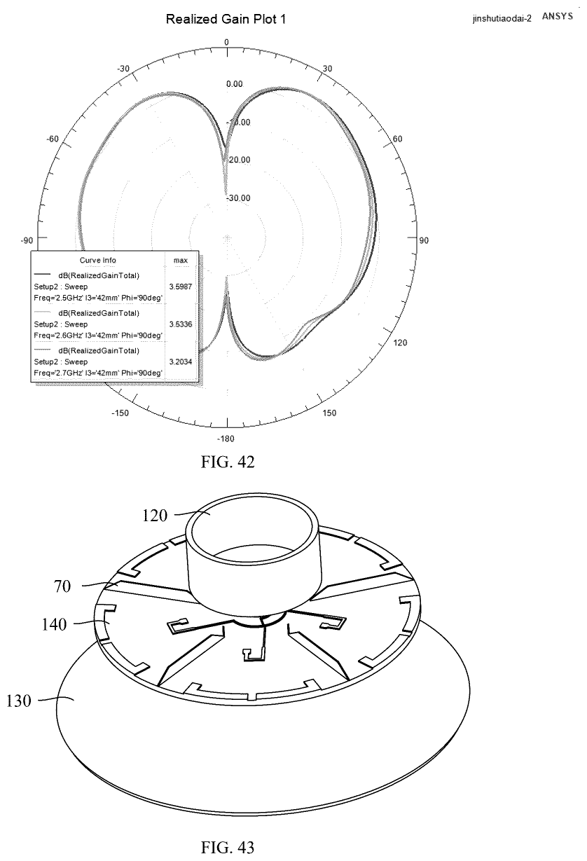

FIG. 42 shows a simulation diagram of the radiation directions of the omnidirectional antenna 1000 shown in FIG. 41. As shown in FIG. 42, the gain of the omnidirectional antenna 1000 is 3.2 dBi, and, as compared with the omnidirectional antenna 1000 not provided with the gain branch 70 in FIG. 27, the gain is increased by 0.2 dBi.

FIG. 43 illustratively shows a partially structural diagram of an omnidirectional antenna 1000. As an example, as shown in FIG. 43, the gain branch 70 is overall trapezoidal, and the gain branch 70 includes a longer side, a shorter side and two hypotenuses, wherein the longer sides are connected to the medium base board 141 and extend in the radial direction of the circular array, and the shorter sides are located on the side of the gain branch 70 away from the medium base board 141.

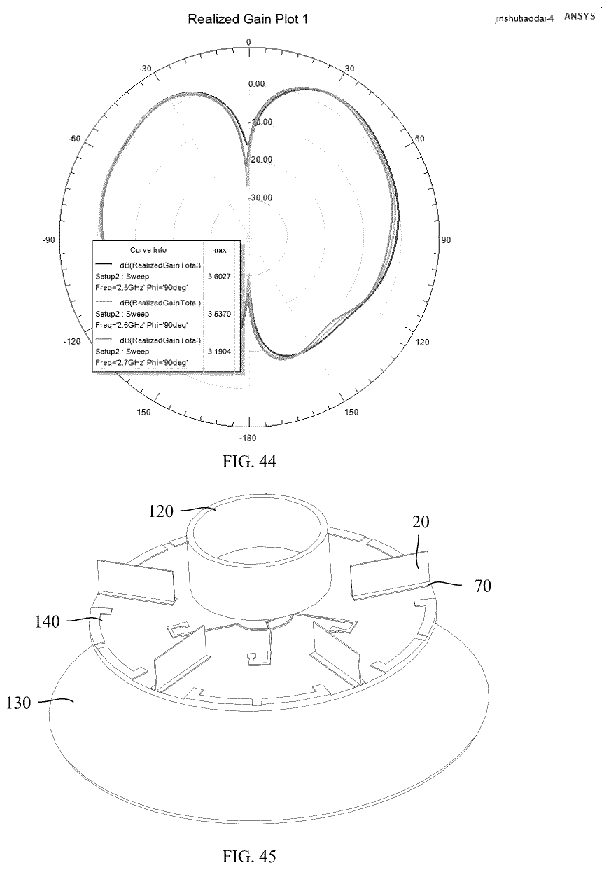

FIG. 44 shows a simulation diagram of the radiation directions of the omnidirectional antenna 1000 shown in FIG. 43. As shown in FIG. 44, the gain of the omnidirectional antenna 1000 is 3.19 dBi, and, as compared with the omnidirectional antenna 1000 not provided with the gain branch 70 in FIG. 27, the gain is increased by 0.19 dBi.

If the gain branch 70 is connected to the side of the medium base board 141 that faces the first electrically conducting layer 142 and protrudes out of the first electrically conducting layer 142 in the first direction, the gain branch 70 may include a plurality of gain sub-branches, and the plurality of gain sub-branches in the same gain branch 70 are arranged separately in the circumferential direction of the circular array, or the plurality of gain sub-branches in the same gain branch 70 may also be arranged separately in the radial direction of the circular array.

The length of the gain branch 70 in the radial direction of the circular array may be regulated according to practical demands.

The end of the gain branch 70 away from the center of the circular array may face the bending part, so that the gain branch 70 and the radiating dipole 10 have a low distance. The radiating dipole 10 may energize the gain branch 70, so that the gain branch 70 generates radiation.

The end of the gain branch 70 that faces the center of the circular array may extend to the earthing component 50, thereby facilitating the electric connection between the gain branch 70 and the earthing component 50. For example, if the first electrically conducting layer 142 includes the radiating dipole 10, and the second electrically conducting layer 143 includes the complementary dipole 60 and the earthing component 50, the gain branch 70 is electrically connected to the earthing component 50. As an example, the medium base board 141 is provided with a through hole, and part of the structure of the gain branch 70 is electrically connected to the earthing component 50 via the through hole.

As an example, the end of the gain branch 70 away from the center of the circular array extends to the edge of the medium plate 140.

Referring continuously to FIG. 3 and FIG. 4, the omnidirectional antenna 1000 may further include the upper taper oscillator 120 and the lower taper oscillator 130, the upper taper oscillator 120 and the lower taper oscillator 130 are arranged separately in the first direction Y, and the taper vertex of the upper taper oscillator 120 and the taper vertex of the lower taper oscillator 130 face each other. The upper taper oscillator 120 and the lower taper oscillator 130 are configured to form vertically polarized radiation.

When the omnidirectional antenna 1000 is installed in the mode shown in FIG. 1, the oscillator located at the upper part is the lower taper oscillator 130, the oscillator located at the lower part is the upper taper oscillator 120, and the upper taper oscillator 120 and the lower taper oscillator 130 are arranged separately in the direction perpendicular to the ground; in other words, the first direction Y is perpendicular to the ground.

Both of the upper taper oscillator 120 and the lower taper oscillator 130 are of a thin-shell structure, and both of the upper taper oscillator 120 and the lower taper oscillator 130 include a taper face, wherein the point part of the taper face is the taper vertex. The taper face may be a circular conical face, a pyramidal face, a truncated circular conical face, a truncated pyramidal face, or an irregular taper face, as long as it is satisfied that, from the end further from the taper vertex to the end of the taper vertex, the size of the taper face gradually decreases. In the embodiments of the present disclosure merely the case is taken as an example for exemplary illustration in which the taper face is a circular conical face and a truncated circular conical face.

Referring continuously to FIG. 4, the upper taper oscillator 120 includes an upper taper face 121 and an upper columnar face 122, and the upper columnar face 122 is connected to the end of the upper taper face 121 away from the lower taper oscillator 130. As an example, if the upper taper face 121 is a circular conical face, the upper columnar face 122 is a circular columnar face. If the upper taper face 121 is a pyramidal face, the upper columnar face 122 is a prismatic face.

Certainly, the lower taper oscillator 130 may also include a lower taper face and a lower columnar face, which is not limited in the embodiments of the present disclosure.

As an example, the upper taper oscillator 120 is symmetrical with respect to its own central axis, the lower taper oscillator 130 is symmetrical with respect to its own central axis, and the central axis of the upper taper oscillator 120 and the central axis of the lower taper oscillator 130 coincide.

The upper taper oscillator 120 and the lower taper oscillator 130 may be made from a conductor, for example, a metal and a carbon fiber. As an example, referring continuously to FIG. 4, the omnidirectional antenna 1000 may further include a signal line. The signal line includes a core wire 1 and a shielding wire 2 nested outside the core wire 1, the shielding wire 2 is electrically connected to the lower taper oscillator 130, the core wire 1 is electrically connected to the upper taper oscillator 120, and the core wire 1 and the lower taper oscillator 130 are insulated from each other. The signal line may be used to send signals to the upper taper oscillator 120 and the lower taper oscillator 130, to energize the upper taper oscillator 120 and the lower taper oscillator 130 to generate the vertically polarized radiation.

In practical applications, the projection of the lower taper oscillator 130 on the medium plate 140 may cover the projection of the upper taper oscillator 120 on the medium plate 140.

The relative position between the upper taper oscillator 120 and the lower taper oscillator 130 directly influences the performance of the omnidirectional antenna 1000, and therefore it is required to fix the upper taper oscillator 120 and the lower taper oscillator 130, to prevent changing of the relative position between the upper taper oscillator 120 and the lower taper oscillator 130 in the omnidirectional antenna 1000. In the related art, the fixing of the upper taper oscillator 120 and the lower taper oscillator 130 is usually realized by using the signal line. For example, the core wire 1 and the shielding wire 2 of the signal line are fixed to each other, the core wire 1 is connected to the upper taper oscillator 120, and the shielding wire 2 is connected to the lower taper oscillator 130, whereby the upper taper oscillator 120 and the lower taper oscillator 130 are fixed. However, because the core wire 1 is fine and is flexible to a certain extent, when the omnidirectional antenna 1000 is being vibrated, the upper taper oscillator 120 easily swings relative to the lower taper oscillator 130.

In view of the above, in the embodiments of the present disclosure a fixing member may be provided separately to realize the fixing of the upper taper oscillator 120 and the lower taper oscillator 130. The fixing member may have various structures, and several feasible structures of the fixing member and the connection mode of the fixing member to the upper taper oscillator 120 and the lower taper oscillator 130 will be described below.

FIG. 5 illustratively shows a partially structural diagram of an omnidirectional antenna 1000. As shown in FIG. 5, the fixing member may include a plurality of fixing frames 150, and the plurality of fixing frames 150 are arranged separately in the circumferential direction of the upper taper oscillator 120. One end of each of the fixing frames 150 is fixedly connected to the upper taper oscillator 120, and the other end of the fixing frame 150 is fixedly connected to the lower taper oscillator 130.

As an example, the fixed connection of the fixing frame 150 to the upper taper oscillator 120 and the lower taper oscillator 130 may be adhesive bonding, ultrasonic welding, riveting, snap fitting and so on, and may also be that the fixing frame 150 and the upper taper oscillator 120 and/or the lower taper oscillator 130 are processed into an integral structure by integral formation.

FIG. 6 illustratively shows a structural diagram of a fixing frame 150. As an example, as shown in FIGS. 5 and 6, the lower taper oscillator 130 is a truncated circular conical face, the truncated circular conical face includes a flat surface facing the upper taper oscillator 120, and the fixing frame 150 includes a first connecting part 153 connected to the flat surface of the lower taper oscillator 130, a second connecting part 151 connected to the upper taper oscillator 120, and a supporting part 152 located between the first connecting part 153 and the second connecting part 151. The supporting part 152 extends in the first direction Y, and the second connecting part 151 inclines by a certain angle relative to the first direction Y, whereby the second connecting part 151 adheres to the surface of the upper taper oscillator 120. The first connecting part 153 extends in a second direction X, whereby the first connecting part 153 adheres to the flat surface of the lower taper oscillator 130.

The plurality of fixing frames 150 may be distributed evenly in the circumferential direction of the taper vertex. FIG. 5 shows a case in which three fixing frames 150 are included. When three fixing frames 150 are included, the included angle between two neighboring fixing frames 150 is 120°, which reduces the quantity of the fixing frames 150 while ensuring the fastness between the upper taper oscillator 120 and the lower taper oscillator 130. Certainly, the quantity of the fixing frames 150 may also be two, four, five, six and so on, and the quantity of the fixing frames 150 is not limited in the embodiments of the present disclosure.

FIG. 7 illustratively shows a partially exploded structural view of an omnidirectional antenna 1000. As shown in FIG. 7, the fixing member may include a fixing tube 160, a first end of the fixing tube 160 is fixedly connected to the lower taper oscillator 130, and the taper vertex of the upper taper oscillator 120 is inserted into a second end of the fixing tube 160.

The taper vertex of the upper taper oscillator 120, after inserted into the second end of the fixing tube 160, may be fixedly connected to the fixing tube 160, to restrict the rotation of the upper taper oscillator 120 relative to the fixing tube 160. The fixed connection of the fixing frame 150 to the upper taper oscillator 120 may be adhesive bonding, ultrasonic welding, riveting, snap fitting and so on.

As an example, referring continuously to FIG. 7, the fixing tube 160 includes a tubular main body 162 and a conical opening 161 connected to one end of the tubular main body 162, and the taper vertex of the upper taper oscillator 120 is inserted into the conical opening 161. The taper of the conical opening 161 may be equal to the taper of the taper vertex of the upper taper oscillator 120, so that, when the taper vertex of the upper taper oscillator 120 is inserted into the conical opening 161, the outer surface of the upper taper oscillator 120 adheres to the inner wall of the conical opening 161, whereby the connection between the upper taper oscillator 120 and the fixing tube 160 is firmer.

That the fixing tube 160 is fixedly connected to the lower taper oscillator 130 refers to that the fixing tube 160 and the lower taper oscillator 130 cannot move relative to each other in the first direction. The fixing tube 160 and the lower taper oscillator 130 may rotate relative to each other around the first direction Y, and may also be not capable of rotating relative to each other.

The end of the lower taper oscillator 130 that faces the upper taper oscillator 120 may be provided with a slot 131, and the first end of the fixing tube 160 is inserted into the slot 131. By realizing the fixing between the fixing tube 160 and the lower taper oscillator 130 by using the fitting between the first end of the fixing tube 160 and the slot 131, the assembling is more convenient.

As an example, the lower taper oscillator 130 includes a flat surface facing the upper taper oscillator 120, the flat surface is provided with a round-ring-shaped first wall protruding out of the flat surface and a second wall nested outside the first wall, and the first wall and the second wall are arranged separately and define the slot 131. The first end of the fixing tube 160 is inserted between the first wall and the second wall.

The first end of the fixing tube 160 may rotate along the first wall and the second wall, or the first end of the fixing tube 160 is fixed relative to the first wall and the second wall; for example, the first end of the fixing tube 160 is interference-fitted to the first wall and the second wall, or an adhesive bonding glue is filled between the first end of the fixing tube 160 and the first wall and the second wall, and so on.

Certainly, the structural form of the slot 131 is not limited thereto, and may also be that the flat surface of the lower taper oscillator 130 that faces the upper taper oscillator 120 depresses in the direction further away from the upper taper oscillator 120 to form the slot 131. The first end of the fixing tube 160 is not limited to a cylindrical tube shape, and the cross-sectional shape perpendicular to the first direction Y of the first end of the fixing tube 160 may also be a triangle, a quadrangle, a pentagon and an irregular shape. In this case, the first wall and the second wall for forming the slot 131 may be adaptively modified according to the shape of the first end of the fixing tube 160.

FIG. 8 illustratively shows a partially exploded structural view of an omnidirectional antenna 1000. As shown in FIG. 8, the slot 131 may include a plurality of sub-slots, the plurality of sub-slots are arranged separately in the circumferential direction of the lower taper oscillator 130, the first end of the fixing tube 160 is provided with a plurality of positioning parts 163, and the plurality of positioning parts 163 are arranged separately in the circumferential direction of the fixing tube 160. The positioning parts 163 are inserted into the sub-slots, to realize the fixing between the fixing tube 160 and the lower taper oscillator 130. Additionally, because the plurality of sub-slots are arranged separately, the positioning parts 163 cannot rotate from one sub-slot to another sub-slot, which can restrict the rotation of the fixing tube 160 relative to the lower taper oscillator 130. For example, if the size of the positioning part 163 is equal to the size of the slot 131, the positioning part 163 cannot rotate inside the sub-slots after inserted into the sub-slots.

As an example, referring continuously to FIG. 8, the slot 131 includes a first sub-slot 131a and a second sub-slot 131b, both of the two sub-slots are of a circular-arc shape, the first end of the fixing tube 160 is provided with two positioning parts 163, and the positioning parts 163 correspond to the sub-slots one to one.

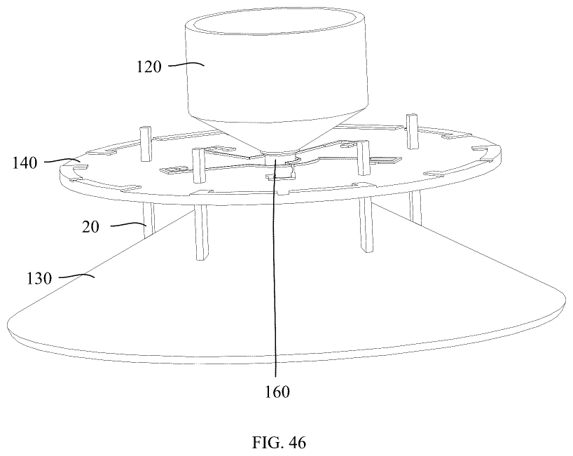

In some embodiments, as shown in FIG. 46, the medium plate 140 is located between the upper taper oscillator 120 and the lower taper oscillator 130 and is fixed to the lower taper oscillator 130, a hollow region 140a is provided at the position of the medium plate 140 that corresponds to the taper vertex, and the first end of the fixing tube 160 is inserted into the hollow region 140a and is fixedly connected to the medium plate 140.

Certainly, the fixing frames 150 and the fixing tube 160 may be included at the same time, which may be configured flexibly according to practical demands in practical applications.

It should be noted that both of the fixing frames 150 and the fixing tube 160 are made from an insulating material (for example, plastic), to prevent short circuiting between the upper taper oscillator 120 and the lower taper oscillator 130 via the fixing frames 150 and the fixing tube 160.

### The Third Embodiment

The third embodiment differs from the first embodiment and the second embodiment mainly in that the omnidirectional antenna 1000 according to the third embodiment includes the gain branch 70 and the parasitic branch 20 at the same time.

The omnidirectional antenna 1000 includes an upper taper oscillator 120, a lower taper oscillator 130, a medium plate 140, a gain branch 70 and a parasitic branch 20. The upper taper oscillator 120 and the lower taper oscillator 130 are arranged separately in the first direction, and the taper vertex of the upper taper oscillator 120 and the taper vertex of the lower taper oscillator 130 face each other. The medium plate 140 is perpendicular to the first direction Y, the medium plate 140 includes a first electrically conducting layer 142, a second electrically conducting layer 143 and a medium base board 141 located between the first electrically conducting layer 142 and the second electrically conducting layer 143, the first electrically conducting layer 142 includes a plurality of radiating components, the plurality of radiating components surround the taper vertex and are arranged in a circular array, and the second electrically conducting layer 143 includes an earthing component 50. The gain branch 70 is connected to the side of the medium base board 141 that faces the first electrically conducting layer 142, the gain branch 70 is located between two neighboring radiating components, and the gain branch 70 is made from a conductor and is separate from the radiating components. The parasitic branch 20 is made from a conductor, the parasitic branch 20 is electrically connected to the upper taper oscillator 120 and protrudes out of the outer surface of the upper taper oscillator 120, or the parasitic branch 20 is electrically connected to the lower taper oscillator 130 and protrudes out of the outer surface of the lower taper oscillator 130.

The particular structures, the positions and the connection relations of the upper taper oscillator 120, the lower taper oscillator 130, the medium plate 140, the gain branch 70 and the parasitic branch 20 may refer to the first embodiment and the second embodiment, and are not discussed further herein.

The omnidirectional antenna 1000 includes the gain branch 70 and the parasitic branch 20 at the same time, which increases the gain of the omnidirectional antenna 1000 and the beam width of the horizontally polarized radiation.

### The Fourth Embodiment

The fourth embodiment differs from the third embodiment mainly in that, in the fourth embodiment the parasitic branch 20 of the omnidirectional antenna 1000 is electrically connected to the gain branch 70. The structures, the positions and the connection relations of the upper taper oscillator 120 and the lower taper oscillator 130 may refer to the first embodiment and the second embodiment, and are not discussed further herein.

The medium plate 140 is perpendicular to the first direction Y, the medium plate 140 includes a first electrically conducting layer 142, a second electrically conducting layer 143 and a medium base board 141 located between the first electrically conducting layer 142 and the second electrically conducting layer 143, the first electrically conducting layer 142 includes radiating components and a gain branch 70, the second electrically conducting layer 143 includes an earthing component 50, and the plurality of radiating components are arranged in a circular array around the taper vertex. The gain branch 70 is located between two neighboring radiating components and is separate from the radiating components. The parasitic branch 20 is electrically connected to the gain branch 70, and the parasitic branch 20 extends in the first direction.

As shown in FIG. 45, the parasitic branch 20 is connected to the medium plate 140, and is electrically connected to the gain branch 70. In the operation of the omnidirectional antenna 1000, the gain branch 70, under the energization by the radiating components, generates an electric current, and the electric current flows through the parasitic branch 20 electrically connected to the gain branch 70, and flows back to the gain branch 70 from the parasitic branch 20, to form a closed loop of the electric current. Because of the closed loop, the current path is lengthened, the current distribution becomes more uniform, and the weak-current area is covered, which affects the fusing of the directional diagram of the horizontally polarized radiation, thereby widening the beam width of the horizontally polarized antenna.

The omnidirectional antenna 1000 includes the gain branch 70 and the parasitic branch 20 at the same time, which increases the gain of the omnidirectional antenna 1000 and the beam width of the horizontally polarized radiation.

It should be noted that, subject to the avoiding of any conflict, one or more of the first embodiment, the second embodiment, the third embodiment and the fourth embodiment of the present disclosure may be combined.

The above are merely particular embodiments of the present disclosure, and the protection scope of the present disclosure is not limited thereto. All of the variations or substitutions that a person skilled in the art can easily envisage within the technical scope disclosed by the present disclosure should fall within the protection scope of the present disclosure. Therefore, the protection scope of the present disclosure should be subject to the protection scope of the claims.

1. An omnidirectional antenna, wherein the omnidirectional antenna comprises an upper taper oscillator, a lower taper oscillator, a medium plate and an auxiliary branch;
the upper taper oscillator and the lower taper oscillator are arranged separately in a first direction, and a taper vertex of the upper taper oscillator and a taper vertex of the lower taper oscillator are opposite to each other;
the medium plate is perpendicular to the first direction, the medium plate comprises a plurality of radiating components, and the plurality of radiating components are arranged in a circular array around the taper vertex; and
the auxiliary branch is made from a conductor, and the auxiliary branch is connected to one or more of the upper taper oscillator, the lower taper oscillator and the medium plate.

2. The omnidirectional antenna according to claim 1, wherein the auxiliary branch comprises a gain branch, the gain branch is provided at the medium plate, and the gain branch is located between two neighboring instances of the radiating components, and is separate from the radiating components.

3. The omnidirectional antenna according to claim 2, wherein the medium plate comprises a first electrically conducting layer, a second electrically conducting layer and a medium base board located between the first electrically conducting layer and the second electrically conducting layer, the radiating components are located at the first electrically conducting layer, the second electrically conducting layer comprises an earthing component, and the gain branch is connected to one side of the medium base board that faces the first electrically conducting layer.

4. The omnidirectional antenna according to claim 3, wherein the gain branch is provided between each two neighboring instances of the radiating components.

5. The omnidirectional antenna according to claim 2, wherein the gain branch extends in a radial direction of the circular array, and the two neighboring instances of the radiating components adjacent to the gain branch is symmetrical with respect to the gain branch.

6. The omnidirectional antenna according to claim 5, wherein the gain branch comprises a plurality of gain sub-branches, and the plurality of gain sub-branches in a same gain branch are arranged separately in the radial direction of the circular array, or the plurality of gain sub-branches in the same gain branch are arranged separately in a circumferential direction of the circular array.

7. The omnidirectional antenna according to claim 6, wherein an axis of symmetry of the two neighboring instances of the radiating components is a first axis of symmetry, and if the plurality of gain sub-branches in the same gain branch are arranged separately in the circumferential direction of the circular array, the plurality of gain sub-branches in the same gain branch are symmetrical with respect to the first axis of symmetry.

8. The omnidirectional antenna according to claim 3, wherein the gain branch is located at the first electrically conducting layer.

9. The omnidirectional antenna according to claim 8, wherein the gain branch comprises a main body extending in a radial direction of the circular array and a plurality of branches connected to the main body, and the plurality of branches are arranged separately in the radial direction of the circular array.

10. The omnidirectional antenna according to claim 9, wherein the main body is of a rectangle, a prismatic shape, a trapezoid, a wave shape or an irregular shape.

11. The omnidirectional antenna according to claim 3, wherein each of the radiating components comprises a radiating dipole, and each of two opposite ends of the radiating dipole comprises a bending part extending toward a center of the circular array.

12. The omnidirectional antenna according to claim 11, wherein one end of the gain branch away from the center of the circular array is opposite to the bending part.

13. The omnidirectional antenna according to claim 11, wherein the second electrically conducting layer further comprises a complementary dipole, an orthographic projection on the medium base board of the radiating dipole and an orthographic projection on the medium base board of the complementary dipole do not overlap, and both of the complementary dipole and the gain branch are electrically connected to the earthing component.

14. (canceled)

15. The omnidirectional antenna according to claim 3, wherein the gain branch is connected to the side of the medium base board that faces the first electrically conducting layer, and the gain branch protrudes out of the first electrically conducting layer in the first direction.

16. The omnidirectional antenna according to claim 1, wherein the auxiliary branch further comprises a parasitic branch, and the parasitic branch protrudes out of an outer surface of one or more of the upper taper oscillator, the lower taper oscillator and the medium plate.

17. The omnidirectional antenna according to claim 16, wherein the parasitic branch surrounds a circumferential direction of the upper taper oscillator or the lower taper oscillator.

18. The omnidirectional antenna according to claim 17, wherein the parasitic branch is of a round-ring shape, and the parasitic branch is nested to an outer surface of the upper taper oscillator or the lower taper oscillator; or
the omnidirectional antenna comprises a plurality of parasitic branches, and the plurality of parasitic branches are arranged separately in the circumferential direction of the upper taper oscillator or the lower taper oscillator.

19.-20. (canceled)

21. The omnidirectional antenna according to claim 17, wherein an orthographic projection of the lower taper oscillator on the medium plate covers an orthographic projection of the upper taper oscillator on the medium plate, the upper taper oscillator comprises a taper face and a columnar face connected to one end of the taper face away from the lower taper oscillator, and the parasitic branch is connected to the columnar face.

22. (canceled)

23. The omnidirectional antenna according to claim 16, wherein an orthographic projection of the lower taper oscillator on the medium plate covers an orthographic projection of the upper taper oscillator on the medium plate, a first end of the parasitic branch is connected to the lower taper oscillator, and a second end of the parasitic branch is connected to and penetrates the medium plate.

24.-32. (canceled)

33. A distributed antenna system, wherein the distributed antenna system comprises the omnidirectional antenna according to claim 1.
